(19) United States
(12) Patent Application Publication
(10) Pub. No.: US 2026/0122714 A1
(43) Pub. Date: Apr. 30, 2026

(54) METHOD AND APPARATUS FOR SELF-OPTIMIZATION IN WIRELESS COMMUNICATION SYSTEMS

(71) Applicant: Samsung Electronics Co., Ltd., Suwon-si, Gyeonggi-do (KR)

(72) Inventor: Aby Kanneath ABRAHAM, Bangalore (IN)

(21) Appl. No.: 19/116,160

(22) PCT Filed: Sep. 18, 2023
(86) PCT No.: PCT/KR2023/014060

§ 371 Date: Mar. 27, 2025

(30) Foreign Application Priority Data
Sep. 29, 2022 (IN) 202241056050
Nov. 3, 2022 (IN) 202241062820
Sep. 7, 2023 (IN) 2022 41056050

(51) Int. Cl. H04W 76/18; H04W 24/10; H04W 76/19

(52) U.S. Cl. CPC H04W 76/18; H04W 24/10; H04W 76/19

(57) ABSTRACT

The disclosure relates to a 5G or 6G communication system for supporting a higher data transmission rate. Embodiments disclosed herein relate to methods (300 to 1300) and systems (100) for performing self-optimization in wireless networks. The method (300 to 1300) includes performing Self-Organizing Networks (SON)/Minimization of Drive Test (MDT) optimizations. The method (700, 800) includes inter-Radio Access Technology (inter-RAT) overwrite protection of signaling based MDT configured in Evolved Universal Terrestrial Radio Access (E-UTRA) by management based MDT configured in New Radio (NR). The method (300, 400) includes optimization of voice fallback from NR to Long-Term Evolution (LTE) through handover. The method (900, 1000) includes handling Random Access Channel (RACH) report in NR, including the RACH report with Network Slice AS Group (NSAG) support. The method (500, 600) includes handling Successful Handover Report (SHR) in NR. The method (1100, 1200, 1300) includes self-optimization of NR-U (NR in Unlicensed spectrum), NR-U deployment and operations.

### TECHNICAL FIELD

Embodiments disclosed herein relate to wireless networks, and more particularly to methods and systems for performing self-optimization in the wireless networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user con-venience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present invention has been made to address at least the above problems and/or disadvantages and to provide at least the advantages described below. Accordingly, for more enhanced communication system, there is a need for method and apparatus for self-optimization in wireless communication systems.

### Solution to Problem

The principal object of embodiments herein is to disclose methods and systems for self-optimization in wireless networks.

Another object of embodiments herein is to disclose methods and systems for performing Self-Organizing Networks (SON)/Minimization of Drive Test (MDT) optimizations.

Another object of the embodiments herein is to disclose methods and systems for inter-Radio Access Technology (inter-RAT) overwrite protection of signaling based MDT configured in Evolved Universal Terrestrial Radio Access (E-UTRA) by management based MDT configured in New Radio (NR).

Another object of the embodiments herein is to disclose methods and systems for providing optimization of voice fallback from NR to Long-Term Evolution (LTE) through handover.

Another object of the embodiments herein is to disclose methods and systems for handling Random Access Channel (RACH) report in NR, including the RACH report with Network Slice AS Group (NSAG) support.

Another object of the embodiments herein is to disclose methods and systems for handling Successful Handover Report (SHR) in NR.

Another object of the embodiments herein is to disclose methods and systems for self-optimization of NR-U (NR in Unlicensed spectrum), NR-U deployment and operations.

### Advantageous Effects of Invention

Advantages, and salient features of the invention will become apparent to those skilled in the art from the following detailed description, which, taken in conjunction with the annexed drawings, discloses exemplary embodiments of the invention. Accordingly present invention, self-optimization can be performed efficiently.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 illustrates a system for performing self-optimization in wireless networks, according to embodiments as disclosed herein;

FIG. 2 illustrates a plurality of modules of a processor of User Equipment (UE), according to embodiments as disclosed herein;

FIG. 3 illustrates a method for performing self-optimization in wireless networks for handling voice fallback during mobility of the UE, according to embodiments as disclosed herein;

FIG. 4 illustrates a flow chart for handling Radio Link Failure (RLF) during a voice fallback, according to embodiments as disclosed herein;

FIG. 5 illustrates a method for performing self-optimization for Successful Handover Reports (SHR) in wireless networks, according to embodiments as disclosed herein;

FIG. 6 illustrates a method for logging a SHR on performing a successful handover as depicted in FIG. 5, according to embodiments as disclosed herein;

FIG. 7 illustrates a method for supporting a Inter-Radio Access Technology (RAT) signaling based logged Minimization of Drive Test (MDT) override protection in wireless networks, according to embodiments as disclosed herein;

FIG. 8 illustrates a method for Inter-Radio Access Technology (RAT) signaling based logged MDT override protection, according to embodiments as disclosed herein;

FIG. 9 illustrates a method for performing self-optimization for handling of Random Access Channel (RACH) report in wireless networks, according to embodiments as disclosed herein;

FIG. 10 illustrates a method for storing feature specific random access information in the UE for Network Slice AS Group (NSAG), according to embodiments as disclosed herein;

FIG. 11 illustrates a method for providing Random Access (RA) reporting during a RA procedure for consistent UpLink (UL) Listen-Before-Talk (LBT) failures in Band Width Part (BWP) in NR-U (NR in Unlicensed spectrum), according to embodiments as disclosed herein;

FIG. 12 illustrates a method for RA reporting during the RA procedure for consistent UL LBT failures in some BWPs, according to embodiments as disclosed herein; and

FIG. 13 illustrates a method for storing RA information for LBT failures, according to embodiments as disclosed herein.

FIG. 14 illustrates a structure of the UE to which embodiments of the disclosure can be applied.

FIG. 15 illustrates a structure of the base station to which embodiments of the disclosure can be applied.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

Accordingly, the embodiments herein provide a method for performing self-optimization in wireless networks. The method includes performing, by a User Equipment (UE), a handover procedure based on a mobility command received from a network. The mobility command comprises a voice fallback indication. The method includes detecting, by the UE, a Radio Link Failure (RLF) during the handover procedure. The method includes logging, by the UE, the detected RLF information in an RLF report. Further, the method includes reporting the logged RLF report to the network for one of Self-Organizing Networks (SON) or Minimization of Drive Test (MDT) optimizations.

Accordingly, the embodiments herein provide a UE which comprises a processor. The processor is configured to perform a handover procedure based on a mobility command received from a network. The mobility command comprises a voice fallback indication. The processor is configured to detect an RLF during the handover procedure. The processor is configured to log the detected RLF information in an RLF report. The processor is configured to report the logged RLF report to the network for one of SON or MDT optimizations.

Accordingly, the embodiments herein provide a method for performing self-optimization in wireless networks. The method includes receiving, by a UE, a Radio Resource Control (RRC) reconfiguration message with a handover command (or sometimes referred to as handover request) from a network. The method includes receiving, by the UE, a configuration from the network to log a Successful Handover Report (SHR) based on one or more conditions if the UE performs a successful handover from a cell or to the cell and the one or more conditions are fulfilled. Configuration for logging SHR may be received in the RRC Reconfiguration message containing handover command or any other RRC Reconfiguration message. The method includes performing, by the UE, a handover from a cell or to the cell, based on the received handover command. The method includes logging, by the UE, the SHR on performing the successful handover from the cell or to the cell and the one or more conditions are fulfilled. Further, the method includes reporting, by the UE, the logged SHR.

Accordingly, the embodiments herein provide a UE which comprises a processor. The processor is configured to receive an RRC reconfiguration message with a handover command from a network. The processor is configured to receive a configuration from the network to log a SHR based on one or more conditions if the UE performs a successful handover from a cell or to the cell and the one or more conditions are fulfilled. The processor is configured to perform a handover from a cell or to the cell, based on the received handover command. The processor is configured to log the SHR on performing the successful handover from the cell or to the cell and the one or more conditions are fulfilled. The processor is configured to report the logged SHR.

Accordingly, the embodiments herein provide a method for performing self-optimization in wireless networks. The method includes sending, by a UE, at least one UE capability information to a network informing that the UE is capable of supporting a Inter-RAT signaling based logged Minimization of Drive Test (MDT) override protection. The method includes receiving, by the UE, an Inter-RAT signaling based logged MDT configuration and a measurement type from the network, based on the UE capability information. The method includes storing, by the UE, the received Inter-RAT signaling based logged MDT configuration and the measurement type in a report. The method includes informing, by the UE, availability of the Inter-RAT signaling based logged MDT configuration and the measurement type to the network during a handover procedure.

Accordingly, the embodiments herein provide a UE which comprises a processor. The processor is configured to send at least one UE capability information to a network informing that the UE is capable of supporting a Inter-RAT signaling based logged MDT override protection. The processor is configured to receive a Inter-RAT signaling based logged MDT configuration and a measurement type from the network, based on the UE capability information. The processor is configured to store the received Inter-RAT signaling based logged MDT configuration and the measurement type in a report. The processor is configured to inform availability of the Inter-RAT signaling based logged MDT configuration and the measurement type to the network during a handover procedure.

Accordingly, the embodiments herein provide a method for performing self-optimization in wireless networks. The method includes receiving, by a UE, a Network Slice AS Group (NSAG) identity and a NSAG priority of at least one NSAG from a core network, and the NSAG identity and a cell reselection priority from a Radio Access Network (RAN). The NSAG is associated with one or more slices or a Single-Network Slice Selection Assistance Information (S-NSSAI). The method includes performing, by the UE, a Random Access (RA) procedure. The method includes logging, by the UE, the NSAG identity and the NSAG priority of the at least one NSAG from the core network, and the NSAG identity and the cell reselection priority from the RAN, in a Random Access Channel (RACH) report, if the RACH has been triggered based on at least one slice of the S-NSSAI while the UE is performing the RA procedure. The method includes reporting, by the UE, the logged RACH report. The method includes sending, by the UE, the RACH report to a base station of the network.

Accordingly, the embodiments herein provide a UE which comprises a processor. The processor is configured to receive a NSAG identity and a NSAG priority of at least one NSAG from a core network, and the NSAG identity and a cell reselection priority from a RAN. The NSAG is associated with one or more slices or a S-NSSAI. The processor is configured to perform an RA procedure. The processor is configured to log the NSAG identity and the NSAG priority of the NSAG from the core network, and the NSAG identity and the cell reselection priority from the RAN, in a RACH report, if the RACH has been triggered based on at least one slice of the S-NSSAI while the UE is performing the RA procedure. The processor is configured to report the logged RACH report. The processor is configured to send the RACH report to a base station of the network.

Accordingly, the embodiments herein provide a method for performing self-optimization in wireless networks. The method includes performing, by a UE, at least one RA procedure in a Bandwidth Part (BWP) of a SpCell (Special Cell) of a network. The method includes switching, by the UE, to an alternate BWP of the SpCell due to consistent UpLink (UL) Listen Before Talk (LBT) failure detection, during the RA procedure. The method includes logging, by the UE, one or more parameters relevant to the RA procedure, in at least one RA report, where the consistent UL LBT failure has detected. The method includes reporting, by the UE, the logged RA report. The method includes sending, by the UE, the RA report to a base station of the network.

Accordingly, the embodiments herein provide a UE which comprises a processor. The processor is configured to perform at least one RA procedure in a BWP of a SpCell of a network. The processor is configured to switch to an alternate BWP of the SpCell due to consistent UL LBT failure detection, during the RA procedure. The processor is configured to log one or more parameters relevant to the RA procedure, in at least one RA report, where the consistent UL LBT failure has detected. The processor is configured to report the logged RA report. The processor is configured to send the RA report to a base station of the network.

These and other aspects of the example embodiments herein will be better ap-preciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

A 5G NR (New Radio) Radio Access Network (RAN) also known as NG-RAN (Next Generation Radio Network) comprises of a number of NR base stations knows as gNBs. NG-RAN may operate in both licensed and unlicensed spectrum.NG-RAN while operating in unlicensed spectrum (NR-U) implements Listen Before Talk (LBT) functionality. Detailed description of such operations is present in 3gpp Layer1/Layer2/Layer3 specifications like TS 38.331/TS38.321/TS38.300 etc. The gNBs can be connected to each other through a Xn interface, and can be connected to various core network elements like AMF (Access and Mobility Management Function), UPF (User Plane Function), and so on. Further, the gNBs can be divided into two physical entities named CU (Centralized Unit) and DU (Distributed Unit). The CU provides support for the higher layers of the protocol stack such as SDAP (Session Data Application Protocol), PDCP (Packet Data Convergence Protocol) and RRC (Radio Resource Control). The DU provides support for the lower layers of the protocol stack such as RLC (Radio Link Control), MAC (Medium Access Control), and Physical layer. Each gNB can have multiple cells serving many UEs (User Equipment).

There are a large number of algorithms and configuration parameters used in NG-RAN. Especially, it is a very difficult task to identify the most optimal radio parameters and operators used to resort to manual techniques like drive tests to identify the optimal parameters. However, such manual parameter tuning is a costly operation since it depends on a lot of factors like the number of users, number of neighbors, maximum throughput in the cell, average throughput in the cell, and so on. Further, whenever a neighbor gNB is installed or a new service is introduced, many of these manual operations need to be repeated.

To resolve this problem, 3GPP has introduced Self-Organizing Networks (SON) techniques in the wireless technologies like New Radio (NR). SON solutions can be divided into three categories such as Self-Configuration, Self-Optimization and Self-Healing. The SON architecture can be a centralized, distributed or a hybrid solution. Mobility Robustness Optimization (MRO) is a SON technique which is used to optimize various parameters related to mobility.

According to 3GPP specifications like TS 38.300 V17.0.0, MRO aims at detecting and enabling correction of following problems:
Connection failure due to intra-system or inter-system mobility;
Inter-system or Intra system Unnecessary Handover (HO) (too early inter-system HO from NR to Evolved UMTS Terrestrial Radio Access Network (E-UTRAN) with no radio link failure);
Inter-system or Intra-system, HO ping-pong.

The MRO provides a means to distinguish the above problems from NR coverage related problems and other problems, not related to mobility. For analysis of connection failures, a User Equipment (UE) makes the Radio Link Failure (RLF) Report available to the network. The UE stores the latest RLF Report, including both Long-Term Evolution (LTE) and NR RLF report until the RLF report is fetched by the network or for 48 hours after the connection failure is detected.

One of the functions of Mobility Robustness Optimization in NR R17 is to detect connection failures that occurred due to Too Early or Too Late inter-system handovers. These problems are defined as follows:
a. Inter-system/Too Late Handover: an RLF occurs after the UE has stayed in a cell belonging to an NG-RAN node for a long period of time; the UE attempts to re-connect to a cell belonging to an E-UTRAN node.
b. Inter-system/Too Early Handover: an RLF occurs shortly after a successful handover from a cell belonging to an E-UTRAN node to a target cell belonging to an NG-RAN node; the UE attempts to re-connect to the source cell or to another cell belonging to an E-UTRAN node.

One of the purposes of inter-system Mobility Robustness Optimization in NR R17 is the detection of a non-optimal use of network resources. In particular, in case of inter-system operations and when NR is considered, the case known as Unnecessary HO to another system is identified. The problem is defined as follows:
a. UE is handed over from NR to E-UTRAN even though quality of the NR coverage was sufficient for the service used by the UE. The handover may therefore be considered as unnecessary HO to another system (i.e. EPS) (too early inter-system HO without connection failure).

In inter-system HO, if the serving cell threshold (NR cell) is set too high, and cell in another system (i.e. EPS) with good signal strength is available, a handover to another system may be triggered unnecessarily, resulting in an inefficient use of the networks. With a lower threshold the UE could have continued in the source system (5GS).

One of the functions of Mobility Robustness Optimization is to detect ping-pongs that occur in inter-system environment. The problem is defined as follows:
a. A UE is handed over from a cell in a source system (e.g. 5GS) to a cell in a target system different from the source system (e.g. EPS), then within a predefined limited time, the UE is handed over back to a cell in the source system, while the coverage of the source system was sufficient for the service used by the UE. The event may occur more than once.

### Inter-Radio Access Technology (IRAT) Mobility in NR Radio Resource Control Connected (RRC CONNECTED) State for Voice Fallback:

If the Inter-RAT handover from NR to LTE is due to voice fallback (UE falls back to LTE for voice services possibly because voice over NR is not supported), network indicates a flag-voice fallback indication, which will be set as true as below.

3GPP Definition for voiceFallbackIndication for Handover is as Below:

### Voice Fallback Indication:

Indicates the handover is triggered by EPS fallback for IMS voice as specified in TS 23.502.

When the voice fallback is needed but the inter-RAT handover is not possible, the network may redirect the UE to Evolved Packet System (EPS) (LTE). RRC message and RRC Release for redirection includes that voice fallback indication set as true. Network (gNodeB) may send RRC Release when the handover is not possible, for example, due to non-availability of interface with LTE node (eNB). If the UE faces radio link failure (RLF) in LTE after the voice fallback handover, the UE may try to select a cell in LTE. If the cell selection is successful, the UE tries to establish a connection in LTE and perform the voice call. If the cell selection is not successful, the UE moves back to the NR cell from where it is handed over to LTE.

### Inter Radio Access Technology (IRAT) Logged Minimization of Drive Test (MDT) Override Protection:

There are two types of MDT supported in NR and LTE-Management based MDT and Signaling based MDT. It may happen that signaling based MDT is overwritten by management based MDT, which may have lower priority. Signaling based MDT is for a single UE whereas management based MDT may be for a group of UEs. IRAT logged MDT override protection is the support of signaling based logged MDT override protection to address the scenario where the signaling based MDT is configured in E-UTRAN when
UE reselects to NR while logged measurements are collected
UE reselects to NR after logged measurements are collected and before uploading the logged MDT report.

The relevant details are available in 3gpp work item description documents like RP-221825. The solutions are built up on the existing intra-NR override protection scheme detailed in 3gpp specifications like TS 38.331 V17.1.0,TS 37.320 V17.1.0 etc.

### Random Access Enhancements in NR Release 17:

NR release 17 further enhances Random Access Channel (RACH) for various features like slicing, small data transmission, reduced capability UEs, coverage enhancements (msg3 repetitions) etc. A number of preambles from available RACH preambles and a number of Physical RACH (PRACH) occasion (RO) may be par-titioned for various features. gNB may also allocate different available RACH occasions to different features as indicated in the system information. For slicing, different slices or slice groups (NSAGs) may be allocated to different RACH resources. The UE receives the NSAG identifiers and the NSAG priorities from the AMF (NAS) in NAS messages like registration update.

Extracts from 3GPP TS 38.331 v17 which Defines Feature Groups and its Charac-Teristics is Given Below.

### Feature Combination:

The feature combination Information Element (IE) indicates a feature or a combination of features to be associated with a set of random access resources (for example, an instance of feature combination preambles). Table 1 below depicts feature combination indication field descriptions.

TABLE 1
Feature Combination Indication field descriptions

Redcap
If present, this field indicates that RedCap is part of this feature combination.
smallData
If present, this field indicates that Small Data is part of this feature combination.
sliceGroup
If present, this field indicates slice group(s) that are part of this feature
combination.
msg3-Repetitions
If present, this field indicates that signaling of msg3 repetition is part of this feature
combination. This field is not configured in a set of preambles that is configured
with 2-step random-access type.

### Feature Combination Preambles:

The IE feature combination preambles associates a set of preambles with a feature combination. For parameters which can be provided in this IE, the UE applies this field value when performing random access using a preamble in this feature combination preambles, otherwise the UE applies the corresponding value as determined by applicable need code, for example, Need S. On a specific Band Width Part (BWP), there can be at most one set of preambles associated with a given feature combination per Random Access (RA) Type (for example, 4-step RACH or 2-step RACH).

The UE sends RACH reports to the network in RRC messages, for example, the UE information response. On receiving the RACH report, gNB Centralized Unit (CU) may send it to gNB Distributed Unit (DU) or Operations, Administration and Maintenance (OAM) SON module or may directly use it for optimizing various parameters related to random access. For example, the number of preambles, configuration of group A and group B preambles, RACH prioritization information, contention resolution timer, number of RACH preambles for 2 step RACH, Physical Uplink Shared Channel (PUSCH) related parameters for 2 step RACH, and so on.

### Successful Handover Reporting:

3GPP introduced successful handover reporting in NR release 17. gNB may configure the UE to report Successful Handover Report (SHR) based on certain thresholds. The thresholds for T310/T312 timers are decided by source gNB while thresholds for T304 timer is decided by target gNB. Detailed description is available in Release 17.1.0 of 3gpp NR specifications likeTS38.331/TS 37.320/TS38.300 etc.

A UE may log various events and information and report to the network for supporting optimizations for minimizing drive tests (MDT). Some of the information that may be logged are RA-Report, RLF-Report and SHR. Contents of the message as per Release 17 (V17.2.0) NR specifications are given below.

RA-ReportList-r16 ::= SEQUENCE (SIZE (1..maxRAReport-r16)) OF RA-Report-r16

| | |
|---|---|
| RA-Report-r16 ::= | SEQUENCE { |
| cellId-r16 | CHOICE { |
| cellGlobalId-r16 | CGI-Info-Logging-r16, |
| pci-arfcn-r16 | PCI-ARFCN-NR-r16 |

},

| | |
|---|---|
| ra-InformationCommon-r16 | RA-InformationCommonr16 |

OPTIONAL,

| | |
|---|---|
| raPurpose-r16 | ENUMERATED {accessRelated, |

```
  bcamFailureRecovery,reconfigurationWithSync,ulUnSynchronized,
  schedulingRequestFailure,noPUCCHResourceAvailable, requestForOtherSI,
```

| | |
|---|---|
| msg3RequestForOtherSI-r17, spare8, spare7, | spare6, spare5, spare4, spare3, |
| | spare2, spare1}, |

```
    ...,
    [[
```

| | |
|---|---|
| spCellID-r17 | CGI-Info-Logging-r16 |

```
  OPTIONAL
    ]]
  }
```

| | |
|---|---|
| RA-InformationCommon-r16 ::= | SEQUENCE { |
| absoluteFrequencyPointA-r16 | ARFCN-ValueNR, |
| locationAndBandwidth-r16 | INTEGER (0..37949), |
| subcarrierSpacing-r16 | SubcarrierSpacing, |

| | |
|---|---|
| msg1-FrequencyStart-r16 | INTEGER |

| | |
|---|---|
| (0..maxNrofPhysicalResourceBlocks-1) | OPTIONAL, |

| | |
|---|---|
| msg1-FrequencyStartCFRA-r16 | INTEGER |

| | |
|---|---|
| (0..maxNrofPhysicalResourceBlocks-1) | OPTIONAL, |

| | |
|---|---|
| msg1-SubcarrierSpacing-r16 | SubcarrierSpacing |

OPTIONAL,

| | |
|---|---|
| msg1-SubcarrierSpacingCFRA-r16 | SubcarrierSpacing |

OPTIONAL,

| | |
|---|---|
| msg1-FDM-r16 | ENUMERATED {one, two, four, eight |

OPTIONAL,

| | |
|---|---|
| msg1-FDMCFRA-r16 | ENUMERATED {one, two, four, eight |

OPTIONAL,

| | |
|---|---|
| perRAInfoList-r16 | PerRAInfoList-r16, |

```
    ...,
    [[
```

| | |
|---|---|
| perRAInfoList-v1660 | PerRAInfoList-v1660 |

```
  OPTIONAL
    ]],
    [[
```

| | |
|---|---|
| msg1-SCS-From-prach-ConfigurationIndex-r16 | ENUMERATED |

| | |
|---|---|
| {kHz1dot25, kHz5, spare2, spare1} | OPTIONAL |

```
    ]],
    [[
```

| | |
|---|---|
| msg1-SCS-From-prach-ConfigurationIndexCFRA-r16 | ENUMERATED |

```
{kHz1dot25, kHz5, spare2, spare1} OPTIONAL
    ]],
    [[
```

| | |
|---|---|
| msgA-RO-FrequencyStart-r17 | INTEGER |

| | |
|---|---|
| (0..maxNrofPhysicalResourceBlocks-1) | OPTIONAL, |

| | |
|---|---|
| msgA-RO-FrequencyStartCFRA-r17 | INTEGER |

| | |
|---|---|
| (0..maxNrofPhysicalResourceBlocks-1) | OPTIONAL, |

| | |
|---|---|
| msgA-SubcarrierSpacing-r17 | SubcarrierSpacing |

OPTIONAL,

| | |
|---|---|
| msgA-RO-FDM-r17 | ENUMERATED {one, two, four, eight} |

OPTIONAL,

| | |
|---|---|
| msgA-RO-FDMCFRA-r17 | ENUMERATED{one,two,four,eight} |

OPTIONAL,

| | |
|---|---|
| msgA-SCS-From-prach-ConfigurationIndex-r17 | ENUMERATED |
| {kHz1dot25, kHz5, spare2, spare1} | OPTIONAL, |

| | |
|---|---|
| msgA-TransMax-r17 | ENUMERATED {n1, n2, n4, n6, n8, |

| | |
|---|---|
| n10, n20, n50, n100, n200} | OPTIONAL, |

| | |
|---|---|
| msgA-MCS-r17 | INTEGER (0..15) |

OPTIONAL,

| | |
|---|---|
| nrofPRBs-PerMsgA-PO-r17 | INTEGER (1..32) |

OPTIONAL,

| | | |
|---|---|---|
| msgA-PUSCH-TimeDomainAllocation-r17 | INTEGER | (1..maxNrofUL- |

| | |
|---|---|
| Allocations) | OPTIONAL, |

| | |
|---|---|
| frequencyStartMsgA-PUSCH-r17 | INTEGER |

| | |
|---|---|
| (0..maxNrofPhysicalResourceBlocks-1) | OPTIONAL, |

| | |
|---|---|
| nrofMsgA-PO-FDM-r17 | ENUMERATED {one, two, four, eight} |

OPTIONAL,

| | |
|---|---|
| dlPathlossRSRP-r17 | RSRP-Range |

OPTIONAL,

| | |
|---|---|
| intendedSIBs-r17 | SEQUENCE (SIZE (1..maxSIB)) OF SIB- |

Type-r17 OPTIONAL,

| | |
|---|---|
| ssbsForSI-Acquisition-r17 | SEQUENCE (SIZE |

| | |
|---|---|
| (1..maxNrofSSBs-r16)) OF SSB-Index | OPTIONAL, |

| | |
|---|---|
| msgA-PUSCH-PayloadSize-r17 | BIT STRING (SIZE (5)) |

OPTIONAL,

| | |
|---|---|
| onDemandSISuccess-r17 | ENUMERATED {true} |

```
  OPTIONAL
    ]]
  }
  PerRAInfoList-r16::= SEQUENCE (SIZE (1..200)) OF PerRAInfo- r16
  PerRAInfoList-v1660::= SEQUENCE (SIZE (1..200)) OF PerRACSI-
RSInfo-v1660
```

| | |
|---|---|
| PerRAInfo-r16 ::= | CHOICE { |
| perRASSBInfoList-r16 | PerRASSBInfo-r16, |
| perRACSI-RSInfoList-r16 | PerRACSI-RSInfo-r16 |

}

| | |
|---|---|
| PerRASSBInfo-r16 ::= | SEQUENCE { |
| ssb-Index-r16 | SSB-Index, |
| numberOfPreamblesSentOnSSB-r16 | INTEGER (1..200), |
| perRAAtemptInfoList-r16 | PerRAAttemptInfoList-r16 |

}

| | |
|---|---|
| PerRACSI-RSInfo-r16 ::= | SEQUENCE { |
| csi-RS-Index-r16 | CSI-RS-Index, |
| numberOfPreamblesSentOnCSI-RS-r16 | INTEGER (1..200) |

}

| | |
|---|---|
| PerRACSI-RSInfo-v1660 ::= | SEQUENCE { |

| | |
|---|---|
| csi-RS-Index-v1660 | INTEGER (1..96) |

```
  OPTIONAL
  }
```

| | |
|---|---|
| PerRAAttemptInfoList-r16 ::= | SEQUENCE (SIZE (1.200)) OF |

PerRAAttemptInfo-r16

| | |
|---|---|
| PerRAAttemptInfo-r16 ::= | SEQUENCE { |

| | |
|---|---|
| contentionDetected-r16 | BOOLEAN |

OPTIONAL,

| | |
|---|---|
| dlRSRPAboveThreshold-r16 | BOOLEAN |

```
  OPTIONAL,
    ...,
    [[
```

| | |
|---|---|
| fallbackToFourStepRA-r17 | ENUMERATED {true} |

```
  OPTIONAL
    ]]
  }
  SIB-Type-r17 ::= ENUMERATED {sibType2, sibType3, sibType4, sibType5,
sibType9, sibType10-v1610, sibType11-v1610, sibType12-v1610,
```

sibType13-v1610, sibType14-v1610, spare6,

spare5, spare4, spare3, spare2, spare1}

| | |
|---|---|
| RLF-Report-r16 ::= | CHOICE { |
| nr-RLF-Report-r16 | SEQUENCE { |
| measResultLastServCell-r16 | MeasResultRLFNR-r16, |
| measResultNeighCells-r16 | SEQUENCE { |

| | |
|---|---|
| measResultListNR-r16 | MeasResultList2NR-r16 |

OPTIONAL,

| | |
|---|---|
| measResultListEUTRA-r16 | MeasResultList2EUTRA-r16 |

OPTIONAL

| | |
|---|---|
| } | OPTIONAL, |

| | |
|---|---|
| c-RNTI-r16 | RNTI-Value, |
| previousPCellId-r16 | CHOICE { |

| | |
|---|---|
| nrPreviousCell-r16 | CGI-Info-Logging-r16, |
| eutraPreviousCell-r16 | CGI-InfoEUTRALogging |

}
OPTIONAL,

| | |
|---|---|
| failedPCellId-r16 | CHOICE { |
| nrFailedPCellId-r16 | CHOICE { |

| | |
|---|---|
| cellGlobalId-r16 | CGI-Info-Logging-r16, |
| pci-arfcn-r16 | PCI-ARFCN-NR-r16 |

},

| | |
|---|---|
| eutraFailedPCellId-r16 | CHOICE { |

| | |
|---|---|
| cellGlobalId-r16 | CGI-InfoEUTRALogging, |
| pci-arfcn-r16 | PCI-ARFCN-EUTRA-r16 |

```
        }
      },
```

| | |
|---|---|
| reconnectCellId-r16 | CHOICE { |

| | |
|---|---|
| nrReconnectCellId-r16 | CGI-Info-Logging-r16, |
| eutraReconnectCellId-r16 | CGI-InfoEUTRALogging |

```
      }
  OPTIONAL,
```

| | |
|---|---|
| timeUntilReconnection-r16 | TimeUntilReconnection-r16 |

OPTIONAL,

| | |
|---|---|
| reestablishmentCellId-r16 | CGI-Info-Logging-r16 |

OPTIONAL,

| | |
|---|---|
| timeConnFailure-r16 | INTEGER (0..1023) |

OPTIONAL,

| | |
|---|---|
| timeSinceFailure-r16 | TimeSinceFailure-r16, |
| connectionFailureType-r16 | ENUMERATED {rlf, hof}, |

| | |
|---|---|
| rlf-Cause-r16 | ENUMERATED {t310-Expiry, |

randomAccessProblem, rlc-MaxNumRetx,

| | |
|---|---|
| beamFailureRecoveryFailure, | lbtFailure-r16, |

bh-

| | |
|---|---|
| rlfRecoveryFailure, t312- | expiry-r17, spare1}, |

| | |
|---|---|
| locationInfo-r16 | LocationInfo-r16 |

OPTIONAL,

| | |
|---|---|
| noSuitableCellFound-r16 | ENUMERATED {true} |

OPTIONAL,

| | |
|---|---|
| ra-InformationCommon-r16 | RA-InformationCommon-r16 |

```
  OPTIONAL,
      ...,
      [[
```

| | |
|---|---|
| csi-rsRLMConfigBitmap-v1650 | BIT STRING (SIZE (96)) |

```
  OPTIONAL
      ]],
      [[
```

| | |
|---|---|
| lastHO-Type-r17 | ENUMERATED {cho, daps, spare2, |

| | |
|---|---|
| spare1} | OPTIONAL, |

| | |
|---|---|
| timeConnSourceDaps-Failure-r17 TimeConnSourceDAPS- | Failure- |

| | |
|---|---|
| r17 | OPTIONAL, |

| | |
|---|---|
| timeSinceCHO-Reconfig-r17 | TimeSinceCHO-Reconfig-r17 |

OPTIONAL,

| | |
|---|---|
| choCellId-r17 | CHOICE { |
| cellGlobalId-r17 | CGI-Info-Logging-r16, |
| pci-arfcn-r17 | PCI-ARFCN-NR-r16 |

```
      }
  OPTIONAL,
```

| | |
|---|---|
| choCandidateCellList-r17 | ChoCandidateCellList-r17 |

```
  OPTIONAL
      ]]
    },
```

| | |
|---|---|
| eutra-RLF-Report-r16 | SEQUENCE { |
| failedPCellId-EUTRA | CGI-InfoEUTRALogging, |
| measResult-RLF-Report-EUTRA-r16 | OCTET STRING, |

```
      ...,
      [[
```

| | |
|---|---|
| measResult-RLM-Report-EUTRA-v1690 | OCTET STRING |

```
  OPTIONAL
      ]]
    }
  }
```

| | |
|---|---|
| SuccessHO-Report-r17 ::= | SEQUENCE { |
| sourceCellInfo-r17 | SEQUENCE { |
| sourcePCellId-r17 | CGI-Info-Logging-r16, |

| | |
|---|---|
| sourceCellMeas-r17 | MeasResultSuccessHONR-r17 |

OPTIONAL,

| | |
|---|---|
| rlf-InSourceDAPS-r17 | ENUMERATED {true} |

```
  OPTIONAL
    },
```

| | |
|---|---|
| targetCellInfo-r17 | SEQUENCE { |
| targetPCellId-r17 | CGI-Info-Logging-r16, |

| | |
|---|---|
| targetCellMeas-r17 | MeasResultSuccessHONR- |

| | |
|---|---|
| r17 | OPTIONAL |

},

| | |
|---|---|
| measResultNeighCells-r17 | SEQUENCE { |

| | |
|---|---|
| measResultListNR-r17 | MeasResultList2NR-r16 |

OPTIONAL,

| | |
|---|---|
| measResultListEUTRA-r17 | MeasResultList2EUTRA-r16 |

```
  OPTIONAL
    }
  OPTIONAL,
```

| | |
|---|---|
| locationInfo-r17 | LocationInfo-r16 |

OPTIONAL,

| | |
|---|---|
| timeSinceCHO-Reconfig-r17 | TimeSinceCHO- Reconfig-r17 |

OPTIONAL,

| | |
|---|---|
| shr-Cause-r17 | SHR-Cause-r17 |

OPTIONAL,

| | |
|---|---|
| ra-InformationCommon-r17 | RA-InformationCommon-r16 |

OPTIONAL,

| | |
|---|---|
| upInterruptionTimeAtHO-r17 | UPInterruption TimeAtHO-r17 |

OPTIONAL,

| | |
|---|---|
| c-RNTI-r17 | RNTI-Value |

```
  OPTIONAL,
    ...
  }
```

| | |
|---|---|
| MeasResultList2NR-r16 ::= | SEQUENCE(SIZE (1..maxFreq)) OF |

MeasResult2NR-r16

| | |
|---|---|
| MeasResultList2EUTRA-r16 ::= | SEQUENCE(SIZE (1..maxFreq)) OF |

MeasResult2EUTRA-r16

| | |
|---|---|
| MeasResult2NR-r16 ::= | SEQUENCE { |

| | |
|---|---|
| ssbFrequency-r16 | ARFCN-ValueNR |

OPTIONAL,

| | |
|---|---|
| refFreqCSI-RS-r16 | ARFCN-ValueNR |

OPTIONAL,

| | |
|---|---|
| measResultList-r16 | MeasResultListNR |

```
  }
    MeasResultListLogging2NR-16::=SEQUENCE(SIZE(1..maxFreq)) OF
MeasResultLogging2NR-r16
```

| | |
|---|---|
| MeasResultLogging2NR-r16 ::= | SEQUENCE { |
| carrierFreq-r16 | ARFCN-ValueNR, |
| measResultListLoggingNR-r16 | MeasResultListLoggingNR-r16 |

}

### NR Operations in the Unlicensed Spectrum:

According to TS 38.300, RA operating with shared spectrum channel access can support the following deployment scenarios:
Scenario A: Carrier aggregation between NR in licensed spectrum (SpCell) and NR in shared spectrum (SCell);
Scenario A.1: SCell is not configured with uplink (Downlink (DL) only);
Scenario A.2: SCell is configured with uplink (DL+Uplink (UL)).
Scenario B: Dual connectivity between LTE in licensed spectrum and NR in shared spectrum (PSCell);
Scenario C: NR in shared spectrum (PCell);
Scenario D: NR cell in shared spectrum and uplink in licensed spectrum;
Scenario E: Dual connectivity between NR in licensed spectrum (PCell) and NR in shared spectrum (PSCell).

Carrier aggregation of cells in shared spectrum is applicable to all deployment scenarios.

The gNB and the UE apply Listen-Before-Talk (LBT) before performing a transmission on a cell which is configured with shared spectrum channel access. When LBT is applied, the transmitter listens to/senses the channel to determine whether the channel is free or busy and performs transmission only if the channel is sensed free. When consistent uplink LBT failures are detected on SpCell, the UE switches to another UL BWP with configured RACH resources on that cell, initiates RACH, and reports the failure via Media Access Control (MAC) Control Element (CE). For PSCell, if consistent uplink LBT failures are detected on all the UL BWPs with configured RACH resources, the UE declares Secondary Cell Group (SCG) RLF and reports the failure to the Master Node (MN) via SCG failure information. For Primary Cell (PCell), if the uplink LBT failures are detected on all the UL BWP(s) with configured RACH resources, the UE declares RLF. If the UE succeeds with a random access procedure in any of the BWPs, the UE doesn't declare RLF.

For the RACH, for On-demand System Information (SI), the UE may not log the Random Access (RA) Report for failed random access procedures. In existing methods, there does not exist a way by which network can know about the random access in the BWPs where RA failed and this lists further optimizations for NR-U (NR in Unlicensed spectrum) RACH.

Existing methods include various issues while performing SON/MDT optimizations. The issues include:
a) Inter-RAT overwrite protection of signaling based MDT configured in E-UTRA by management based MDT configured in NR.
b) Optimization of Voice fallback from NR to LTE through handover.
c) Handling of RACH report in NR including RACH report with NSAG support.
d) Handling of SHR in NR for NR-U (NR operations in Unlicensed spectrum)
e) Optimizing NR-U operations

Hence, there is a need in the art for solutions which will overcome the above mentioned drawback(s), among others.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and soon”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

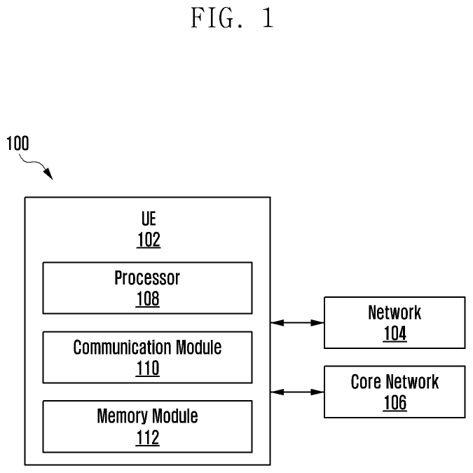

The embodiments herein provide methods and systems for Self-Organizing Networks (SON)/Minimization of Drive Test (MDT) optimizations in wireless networks. Referring now to the drawings, and more particularly to FIGS. 1 through 13, where similar reference characters denote corresponding features consistently throughout the figures, there are shown embodiments.

FIG. 1 illustrates a system 100 for performing self-optimization in wireless networks. The system 100 comprises a User Equipment (UE) 102, a network 104, and a core network 106 for performing SON/MDT optimizations. The UE 102 further comprises a processor 108, a communication module 110, and a memory module 112.

In an embodiment herein, the processor 108 is configured to detect Radio Link Failures (RLF) during handover procedures due to voice fall back, and log the detected RLF for one of SON or MDT optimizations. In an embodiment herein, the processor 108 is configured to log a Successful Handover Report (SHR) based on one or more conditions, if the UE 102 performs a successful handover. In an embodiment herein, the processor 108 is configured to inform UE capability of supporting a Inter-Radio Access Technology (RAT) signaling based logged MDT override protection to the network 104 during a handover procedure. In an embodiment herein, the processor 108 is configured to report to a base station of the network 104, if a Random Access Channel (RACH) is triggered by a Single-Network Slice Selection Assistance Information (S-NSSAI) while the UE 102 is performing the Random Access (RA) procedure. In an embodiment herein, for NR-U (New Radio in Unlicensed spectrum), the processor 108 is configured to log one or more parameters relevant to at least one RA procedure to the base station of the network 104, when the UE 102 switches to an alternate Bandwidth Part (BWP) of a SpCell (Special Cell) of the network 104 due to consistent UpLink (UL) Listen Before Talk (LBT) failure detection. The processor 108 is configured to report the logged parameters.

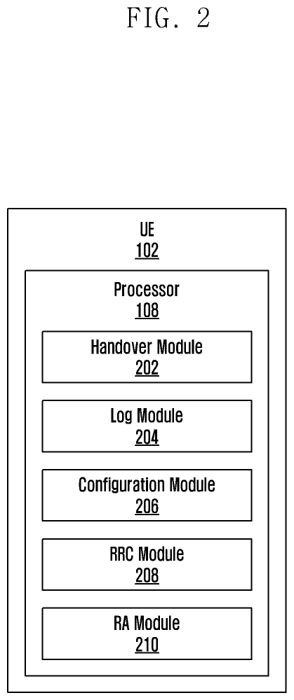

The processor 108 further comprises a handover module 202, a log module 204, a configuration module 206, an Radio Resource Control (RRC) module 208, and an RA module 210, as depicted in FIG. 2.

In an embodiment herein, the handover module 202 can receive a mobility command from the network 104 and perform a handover procedure based on the mobility command. The mobility command can comprise a voice fallback indication. In an embodiment herein, the handover module 202 can receive a handover command and perform a handover from a cell or to the cell. In an embodiment herein, the handover module 202 can detect one or more RLFs during the handover procedure.

In an embodiment herein, the log module 204 can log the detected RLF information from the handover module 202 in a RLF report. The log module 204 can send or report the RLF report to the network 104 for one of SON or MDT optimizations. In an embodiment herein, the log module 204 can log a Cell Global Identity (CGI) of a source cell of the mobility command as a reestablishment cell in the RLF report. The log module 204 logs the CGI of the source cell, when the UE 102 attempts to select an Evolved Universal Terrestrial Radio Access (E-UTRA) cell after an RLF has occurred and was not able to select the E-UTRA cell. The log module 204 can set eutraRecon-nectCellld-r16 (as in 3gpp NR RRC specification, TS 38.331) in the RLF report to the CGI of the E-UTRA cell where UE 102 has connected, if the UE 102 has selected a E-UTRA cell successfully and has successfully reconnected to the E-UTRA cell. In an embodiment herein, the log module 204 can log a SHR on performing a successful handover from the cell or to the cell and if one or more conditions are fulfilled. The log module 204 can report the logged SHR. In an embodiment herein, the log module 204 can log at least one of an indication whether there is a consistent UL LBT failure in a source cell, a number of LBT failures in the source cell, value of LBT_COUNTER of the source cell, and one or more Received Signal Strength Indicator (RSSI) measurements and one or more channel occupancy measurements of the source cell and neighboring cells, in the SHR report, if a configuration (of a satisfied condition) is provided by the source cell of the network 104 in NR-U. As normally done, the logged indication whether there is a consistent UL LBT failure in a source cell, a number of LBT failures in the source cell, value of LBT_COUNTER of the source cell, and one or more Received Signal Strength Indicator (RSSI) measurements and one or more channel occupancy measurements of the source cell and neighboring cells represent those values at the time of logging (i.e., at the time of successful handover where the thresholds are fulfilled). In an embodiment herein, the log module 204 can log at least one of an indication whether there is a consistent UL LBT failure in a target cell, a number of LBT failures in the target cell, value of LBT_COUNTER of the target cell, and one or more RSSI measurements and one or more channel occupancy measurements of the target cell and neighboring cells, in the SHR report, if a configuration (of a satisfied condition) is provided by the target cell of the network 104. In an embodiment herein, the log module 204 can store a Inter-RAT signaling based logged MDT configuration and a measurement type, in a report, received from the network 104. In an embodiment herein, the log module 204 can log a Network Slice AS Group (NSAG) identity and a NSAG priority of a NSAG received from a core network 106 (such as Access and Mobility Management Function (AMF)), and the NSAG identity and a cell reselection priority received from a Radio Access Network (RAN) in a RACH report. The log module 204 can report the logged RACH report. The log module 204 can log the NSAG identity, the NSAG priority, and the cell reselection priority, if the RACH has been triggered based on at least one slice of an S-NSSAI while the UE 102 is performing a RA procedure. The NSAG identities of one or more NSAGs are listed in the order of one or more Non-Access Stratum (NAS) provided NSAG priorities, in the RACH report. The log module 204 can report the logged RACH report. The log module 204 can send the RACH report to the base station of the network 104. In an embodiment herein, the log module 204 can log one or more parameters relevant to at least one RA procedure, in at least one RA report, where a consistent UL LBT failure has detected. The log module 204 can report the logged RA report. The log module 204 can log the parameters relevant to the RA procedure when the RA procedure is successful in an alternate BWP. The log module 204 can send the RA report to the base station of the network 104.

In an embodiment herein, the configuration module 206 can apply a source cell configuration using the logged CGI of the source cell which is obtained from the log module 204. In an embodiment herein, the configuration module 206 can receive a configuration from the network 104 to log the SHR based on one or more conditions such as the threshold percentages for T310 or T312 or T304 timers. If the UE 102 performs a successful handover from the cell or to the cell and the conditions are fulfilled, UE logs SHR. The configuration provided by the source cell can comprise, but not limited to, a thresholdpercentageT310 and a thresholdpercentageT312 in the source cell. The configuration provided by the target cell comprises a thresholdper-centageT304 in the target cell. In an embodiment herein, the configuration module 206 can send at least one UE capability information to the network 104 informing that the UE 102 is capable of supporting a Inter-RAT signaling based logged MDT override protection. The configuration module 206 can receive a Inter-RAT signaling based logged MDT configuration and a measurement type from the network 104 based on the UE capability information. The configuration module 206 can set the availability of the Inter-RAT signaling based logged MDT configuration and the measurement type as true when a configured timer is running.

In an embodiment herein, the RRC module 208 can send an RRC reestablishment to the base station of the network 104, using the source cell configuration from the configuration module 206. In an embodiment herein, the RRC module 208 can receive an RRC reconfiguration message with a handover command, from the network 104. The RRC module 208 can receive the RRC reconfiguration message from the network. The RRC module 208 can verify if the UE 102 has logged measurements for the network and if Registered Public Land Mobile Network (RPLMN) is stored in the report of the log module 204. The RRC module 208 can inform availability of the Inter-Radio Access Technology (RAT) signaling based logged MDT configuration and the measurement type to the network during a handover procedure, if the UE 102 has logged measurements and the RPLMN is stored. The RRC module 208 can inform availability of the Inter-RAT signaling based logged MDT configuration and the measurement type to the network 104 via an RRC reconfiguration complete message. The RRC module 208 can inform availability of the Inter-RAT signaling based logged MDT configuration and the measurement type to the network via an RRC SetupComplete message or RRCResumeComplete message or RRCReestablishmentComplete message.

In an embodiment herein, the RA module 210 can receive a NSAG identity and a NSAG priority of at least one NSAG from a core network 106. The RA module 210 can receive a NSAG identity and a cell reselection priority from the RAN. The NSAG is associated with one or more slices or a S-NSSAI. The RA module 210 can receive the NSAG identity and the NSAG priority of the NSAG via one or more NAS messages from the core network 106 (for e.g. from the core network functions such as AMF). The RA module 210 can perform an RA procedure. If at least one slice of the S-NSSAI triggers a RACH while the UE 102 is performing the RA procedure, then the NSAG identity and the NSAG priority of the NSAG from the core network 106, and the NSAG identity and the cell reselection priority from the RAN can be logged and reported in the RACH report. In an embodiment herein, the RA module 210 can perform at least one RA procedure in a BWP of a SpCell of the network 104. The RA module 210 can detect one or more consistent UL LBT failures during the RA procedure in NR-U. The RA module 210 can switch to an alternate BWP of the SpCell due to consistent UL LBT failure detection, during the RA procedure. The parameters relevant to the RA procedure can be logged and reported where the consistent UL LBT failure has detected. The parameters relevant to the RA procedure can be logged and reported when the RA procedure is successful in the alternate BWP. The parameters relevant to the RA procedure can be, but not limited to location and bandwidth information of the BWP, subcarrier spacing information of the BWP, and absolute frequency point information of the BWP.

In an embodiment herein, the processor 108 can process and execute data of a plurality of modules of the UE 102 respectively. The processor 108 can be configured to execute instructions stored in the memory module 112. The processor 108 may comprise one or more of microprocessors, circuits, and other hardware configured for processing. The processor 108 can be at least one of a single processer, a plurality of processors, multiple homogeneous or heterogeneous cores, multiple Central Processing Units (CPUs) of different kinds, microcontrollers, special media, and other accelerators. The processor 108 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

In an embodiment herein, the plurality of modules of the processor 108 of the UE 102 can communicate with the network 104 and the core network 106 via the communication module 110. The communication module 110 may be in the form of either a wired network or a wireless communication network module. The wireless communication network may comprise, but not limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 112 may comprise one or more volatile and non-volatile memory components which are capable of storing data and instructions of the modules of the UE 102 to be executed. Examples of the memory module 112 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 112 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 112 may, in some examples, be considered a non-transitory storage medium. The term “non-transitory” may indicate that the storage medium is not embodied in a carrier wave or a propagated signal. However, the term “non-transitory” should not be in-terpreted to mean that the memory module 112 is non-movable. In certain examples, a non-transitory storage medium may store data that can, over time, change (for example, in Random Access Memory (RAM) or cache).

FIG. 1 shows example modules of the UE 102 respectively, but it is to be understood that other embodiments are not limited thereon. In other embodiments, the UE 102 may include less or more number of modules. Further, the labels or names of the modules are used only for illustrative purpose and does not limit the scope of the invention. One or more modules can be combined together to perform same or sub-stantially similar function in the UE 102.

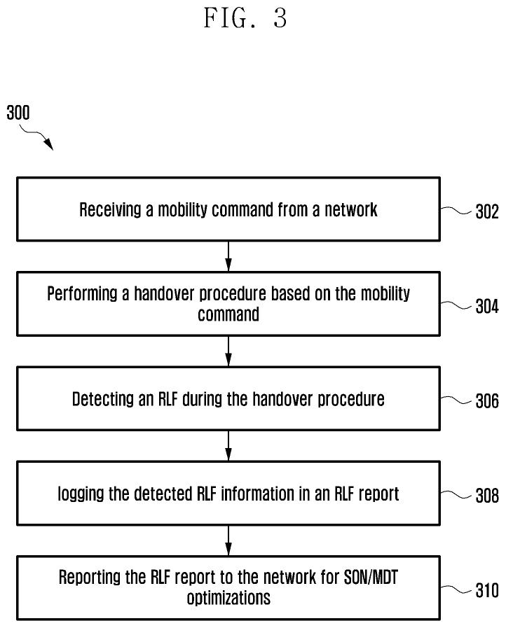

FIG. 3 illustrates a method 300 for performing self-optimization in wireless networks for handling voice fallback during mobility of the UE 102 from the network 104. The method 300 comprises receiving, by the processor 108 of the UE 102, a mobility command from the network 104, as depicted in step 302. The mobility command includes a voice fallback indication. The method 300 comprises performing, by the processor 108, a handover procedure based on the mobility command, as depicted in step 304. The method 300 comprises detecting, by the processor 108, an RLF during the handover procedure, as depicted in step 306. The method 300 comprises logging, by the processor 108, the detected RLF information in an RLF report, as depicted in step 308. Thereafter, the method 300 comprises reporting, by the processor 108, the RLF report to the network 104 for one of SON or MDT optimizations, as depicted in step 310.

The various actions in method 300 may be performed in the order presented, in a different order or simultaneously. Further, in some embodiments, some actions listed in FIG. 3 may be omitted.

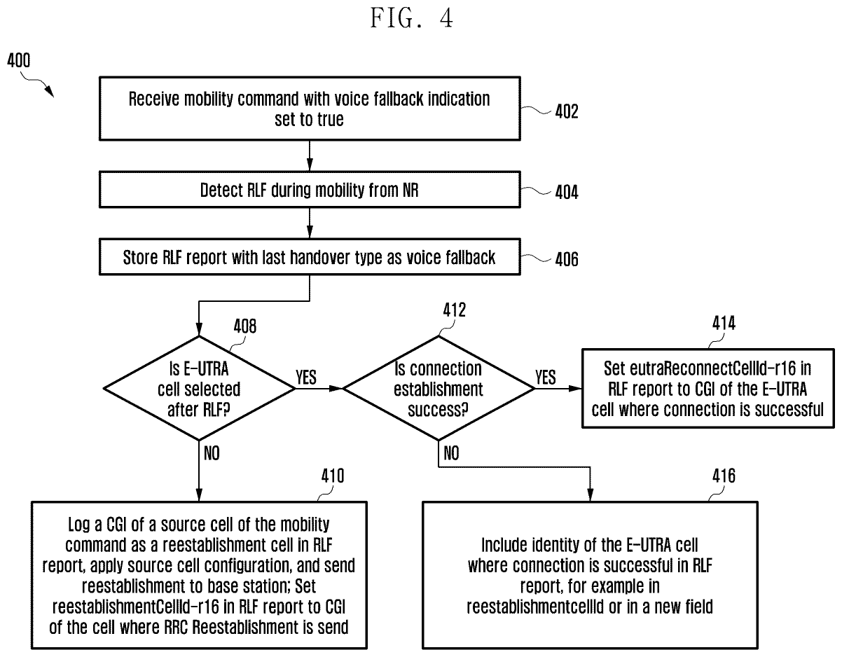

FIG. 4 illustrates a flow chart 400 for handling RLF during a voice fallback. As depicted in step 402, the UE 102 receives a mobility command (such as NR mobili-tyFromNRCommand) from NR, including a field with voice fallback indication (such as NR voiceFallbackIndication IE) set to true. As depicted in step 404, the UE 102 detects an RLF during mobility from the NR. The UE 102 logs and stores the last handover type (NR RRC IE lastHO-Type-r17) in the RLF report as voice fallback (for example, an indication that handover type is inter-Radio Access Technology (RAT) handover for voice fallback), as depicted in step 406.

The UE 102 verifies whether E-UTRA cell has been selected after RLF has occurred, as depicted in step 408. RLF detected during the mobilityFromNR procedure may be a RLF in LTE. If the UE 102 has attempted to select an E-UTRA cell after the RLF has occurred and was not able to select the E-UTRA cell, then the UE 102 logs a CGI of a source cell of the mobility command as a reestablishment cell in the RLF report, as depicted in step 410. The UE 102 applies source cell configuration using the logged CGI of the source cell. The UE 102 sends an RRC reestablishment to the base station of the network 104, using the source cell configuration. The UE 102 sets NR RRC IE reestablishmentCellld-r16 in the RLF report to the CGI of the cell where the RRC reestablishment (RRCReestablishmentRequest) is sent.

The UE 102 verifies the connection establishment, as depicted in step 412, if the UE 102 is able to select the E-UTRA cell after the RLF has occurred. The UE 102 sets NR RRC IE eutraReconnectCellld-r16 in the RLF report to the CGI of the E-UTRA cell where UE 102 has connected, as depicted in step 414, if the UE 102 has selected a E-UTRA cell successfully and has successfully reconnected to the E-UTRA cell. If the UE 102 is able to select the E-UTRA cell after the RLF has occurred, and the connection establishment is not successful, then the UE 102 includes identity of the E-UTRA cell where connection is successful, in the RLF report, for example in reestablishmentcellld or in a new field, as depicted in step 416. Network nodes such as NR gNBs, retrieves the RLF report and identifies various information such as the cell where UE 102 has performed reestablishment after a voice fallback handover and also identifies that there was no suitable E-UTRA cell at the point where the Inter-RAT handover has occurred or the identity of E-UTRA cell if there was a cell where the RRC connection was successful after the RLF and optimizes the Inter-RAT mobility.

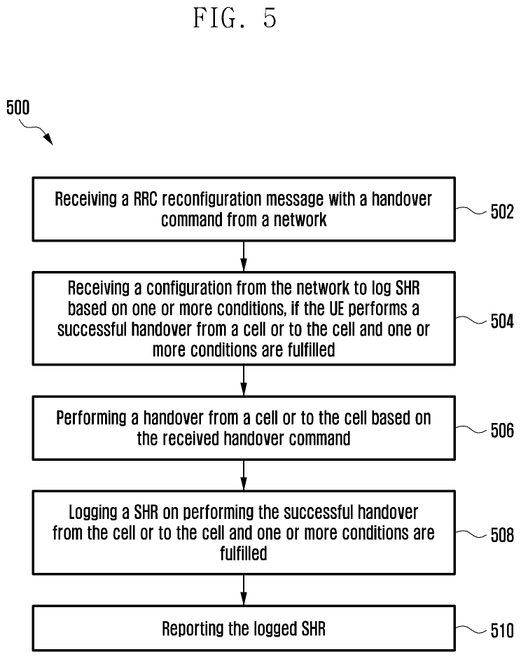

FIG. 5 illustrates a method 500 for performing self-optimization for Successful Handover Reports (SHR) in wireless networks. The method 500 includes receiving, by the processor 108 of the UE 102, an RRC reconfiguration message with a handover command, from a network 104, as depicted in step 502. The method 500 includes receiving, by the processor 108, a configuration from the network 104 to log a SHR based on one or more conditions if the UE 102 performs a successful handover from a cell or to a cell and one or more conditions are fulfilled, as depicted in step 504. Configuration of conditions may happen in a RRC message prior to receiving a handover command or in a RRC message which carries a handover command. The method 500 includes performing, by the processor 108, a handover from a cell or to the cell, as depicted in step 506, based on the received handover command. The method 500 includes logging, by the processor 108, a SHR on performing the successful handover from the cell or to the cell and the one or more conditions is fulfilled, as depicted in step 508. The method 500 includes reporting, by the processor 108, the logged SHR, as depicted in step 510.

The various actions in method 500 may be performed in the order presented, in a different order or simultaneously. Further, in some embodiments, some actions listed in FIG. 5 may be omitted.

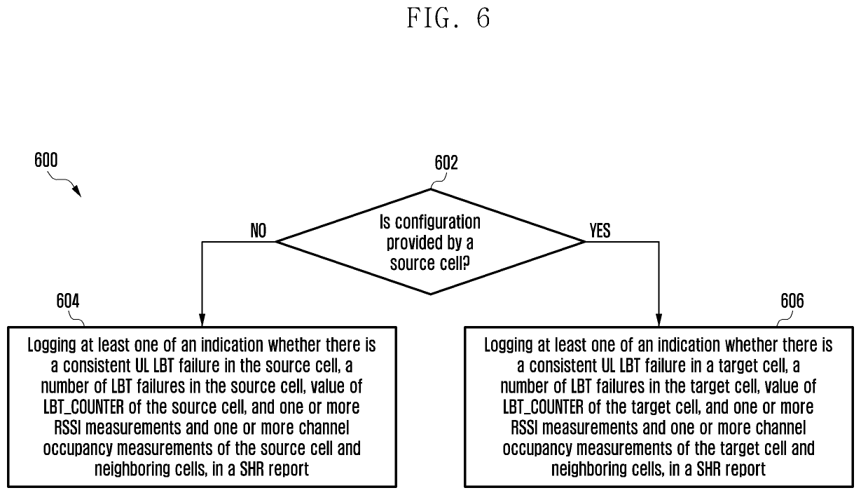

FIG. 6 illustrates a method 600 for logging a SHR on performing a successful handover as depicted in FIG. 5. The method 600 includes verifying, by the processor 108 of the UE 102, if the configuration of a satisfied condition is provided by a source cell of the network 104, as depicted in step 602. If the configuration is provided by the source cell, then the UE 102 logs at least one of an indication whether there is a consistent UL LBT failure in the source cell, a number of LBT failures in the source cell, value of LBT_COUNTER of the source cell, and one or more RSSI measurements and one or more channel occupancy measurements of the source cell and neighboring cells, in the SHR report, as depicted in step 604. The indication whether there is a consistent UL LBT failure in the source cell, a number of LBT failures in the source cell, value of LBT_COUNTER of the source cell, and one or more RSSI measurements and one or more channel occupancy measurements of the source cell and neighboring cells is identified at the time of logging the same. The configuration provided by the source cell can be, but not limited to a thresholdpercentageT310, a thresholdpercentageT312, and so on. If the configuration is provided by a target cell, then the UE 102 logs at least one of an indication whether there is a consistent UL LBT failure in the target cell, a number of LBT failures in the target cell, value of LBT_COUNTER of the target cell, and one or more RSSI measurements and one or more channel occupancy measurements of the target cell and neighboring cells, in the SHR report, as depicted in step 606. The configuration provided by the target cell can be, but not limited to thresholdpercentageT304, thresholdpercentageT310, threshold-percentageT312, thresholdpercentageT304 etc., are as defined in 3gpp specifications such as TS 38.331.

The various actions in method 600 may be performed in the order presented, in a different order or simultaneously. Further, in some embodiments, some actions listed in FIG. 6 may be omitted.

In an embodiment herein, if the UE 102 performs a successful handover from a NR-U cell or to a NR-U cell, and if it is configured to log a SHR based on certain conditions and if those conditions are fulfilled, then the UE 102 also logs the time the handover occurred in the SHR.

In an embodiment herein, the UE 102 logs the time the handover completed (for example, random access completed in the target cell) in the successful handover report. In an embodiment herein, the UE 102 logs the time the handover is initiated (for example, the RRC reconfiguration message for handover is received) in the SHR.

In an embodiment herein, the UE 102 logs the time the handover completed in the SHR if the configuration (of satisfied condition) is provided by the target cell, while the UE 102 logs the time handover is initiated if the configuration (of the satisfied condition) is provided by the source cell.

In an embodiment herein, the UE 102 includes whether there was consistent UL LBT failures in both the source cell and the target cell, the number of LBT failures in both the source cell and the target cell and value of LBT_COUNTER (variable defined in TS 38.321) in both the source cell and the target cell, and the RSSI measurements and channel occupancy measurements of the source cell, target cell and neighboring cells in the SHR whenever such values are available. In an embodiment herein, the UE 102 includes the information in the SHR, irrespective of whether the threshold conditions are fulfilled.

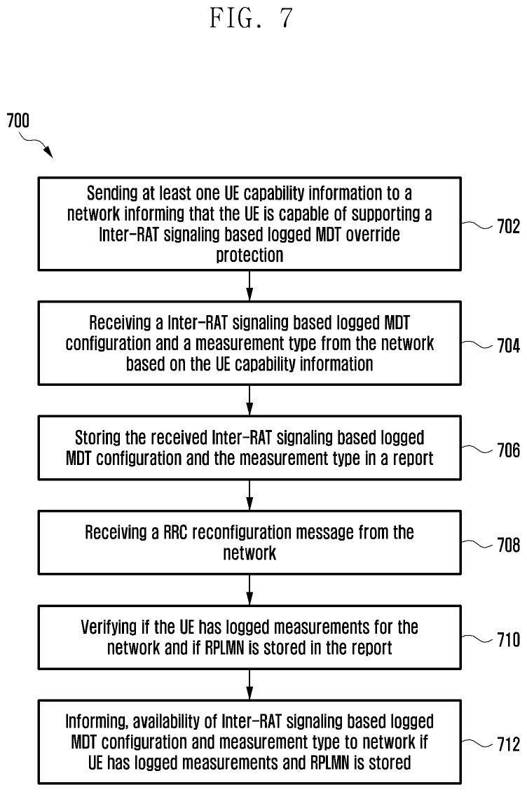

FIG. 7 illustrates a method 700 for supporting a Inter-RAT signaling based logged MDT override protection in wireless networks. The method 700 comprises sending, by the processor 108 of the UE 102, at least one UE capability information to a network 104 informing that the UE 102 is capable of supporting a signaling (Inter-RAT) based logged MDT override protection, as depicted in step 702. The method 700 comprises receiving, by the processor 108, a Inter-RAT signaling based logged MDT configuration and a measurement type from the network 104, based on the UE capability information, as depicted in step 704. The method 700 comprises storing, by the processor 108, the received Inter-RAT signaling based logged MDT configuration and the measurement type in a report, as depicted in step 706. The method 700 comprises receiving, by the processor 108, a RRC reconfiguration message from the network, as depicted in step 708. The method 700 comprises verifying, by the processor 108, if the UE 102 has logged measurements for the network and if Registered Public Land Mobile Network (RPLMN) is stored in the report, as depicted in step 710. The method 700 comprises informing, by the processor 108, availability of the Inter-RAT signaling based logged MDT configuration and the measurement type to the network via an RRC reconfiguration complete message during a handover procedure, if the UE 102 has logged measurements and the RPLMN is stored, as depicted in step 712. The UE 102 sets the availability of Inter-RAT signaling based logged MDT configuration and the measurement type as true when a configured timer is running.

The various actions in method 700 may be performed in the order presented, in a different order or simultaneously. Further, in some embodiments, some actions listed in FIG. 7 may be omitted.

In an embodiment herein, a UE 102 which supports Inter-RAT signaling based logged MDT override protection may inform the eNB (evolved Node B or eNodeB) about its capability for supporting Inter-RAT signaling based logged MDT override protection using E-UTRA capability signaling. The capability indicates the eNB that the UE 102 can process the E-UTRA LoggedMDTConfiguration including the MDT type. E-UTRA informs the MDT type, (as signaling MDT or not) based on the received capability from UE 102. eNB may use the received capability for providing the relevant configurations to the UEs. When connected to the gNB (Next Generation Node B or gNodeB), the UE 102 may inform the gNB about the same capability through NR UE capability signaling. In an embodiment herein, if the UE 102 is capable of Inter-RAT signaling based logged MDT override protection, then the UE 102 is also capable of NR signaling based logged MDT override protection. The UE 102 receives measurement type of signaling logged MDT in E-UTRA logged MDT configuration, for example, in sigLoggedMeasType and stores in VarLogMeasReport.

In an embodiment herein, if the UE 102 receives RRC reconfiguration (for example, NR RRC reconfiguration message from gNB through eNB) during mobility to NR and if the UE 102 has signaling based logged measurements available for E-UTRA and if the RPMN is included in plmn-IdentityList stored in VarLogMeasReport, then the UE 102 informs the gNB whether the signaling based logged measurements or signaling based logged measurement configuration are available through a NR RRC reconfiguration complete as given below.
2>if the RRC reconfiguration includes the reconfigurationWithSync in sp-CellConfig of an MCG:
3>if the UE has logged measurements available for NR or E-UTRA and if the RPLMN is included in plmn-IdentityList stored in VarLogMeasReport:
4>if the sigLoggedMeasType in VarLogMeasReport is included:
5>include the sigLogMeasConfigAvailable in the RRCReconfigurationComplete message and set it according to the following:
6>if T330 timer is running:
7>set sigLogMeasConfigAvailable to true in the RRCReconfigurationComplete message;
6>else:
7>set sigLogMeasConfigAvailable to false in the RRCReconfigurationComplete message;

In an embodiment herein, if the UE 102 informs about the logged measurements configuration for E-UTRA while T330 is running by including and setting sigLogMeasConfigAvailable to true in at least one of the RRCReestablishmentComplete message, RRCReconfigurationComplete, RRCSetupComplete and RRCResumeComplete message (i.e., if T330 timer is running and the logged measurements configuration is for E-UTRA, then the UE 102 sets sigLogMeasConfigAvailable when sigLoggedMeasType in VarLogMeasReport is included). If the UE 102 has logged measurements available for E-UTRA when sigLoggedMeasType in VarLogMeasReport is included, then the UE 102 includes and sets sigLogMeasConfigAvailable to false in at least one of the RRCReestablishmentComplete message, RRCReconfigurationComplete, RRCSetupComplete and RRCResumeComplete message.

In an embodiment herein, sigLogMeasConfigAvailable is the same IE in NR RRC message for NR and E-UTRA override protection, for example, irrespective of whether Inter-RAT signaling based MDT is configured in E-UTRAN or NR, UE 102 reports same variable to NR network (gNB). In an embodiment herein, separate RRC IE is used for NR and E-UTRA.

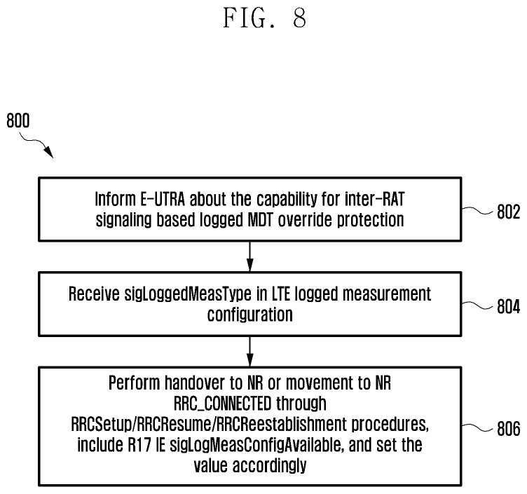

FIG. 8 illustrates a method 800 for Inter-RAT signaling based logged MDT override protection. The method 800 comprises informing, by the processor 108 of the UE 102, E-UTRA about the capability for inter-RAT signaling based logged MDT override protection, as depicted in step 802. The method 800 comprises receiving, by the processor 108, sigLoggedMeasType in LTE logged measurement configuration, as depicted in step 804. The method 800 comprises performing, by the processor 108, handover to NR or movement to NR RRC_CONNECTED through at least one of RRCSetup, RRCResume, and RRCReestablishment procedures, including R17 IE sigLogMeasConfigAvailable and setting the value accordingly, as depicted in step 806.

The various actions in method 800 may be performed in the order presented, in a different order or simultaneously. Further, in some embodiments, some actions listed in FIG. 8 may be omitted.

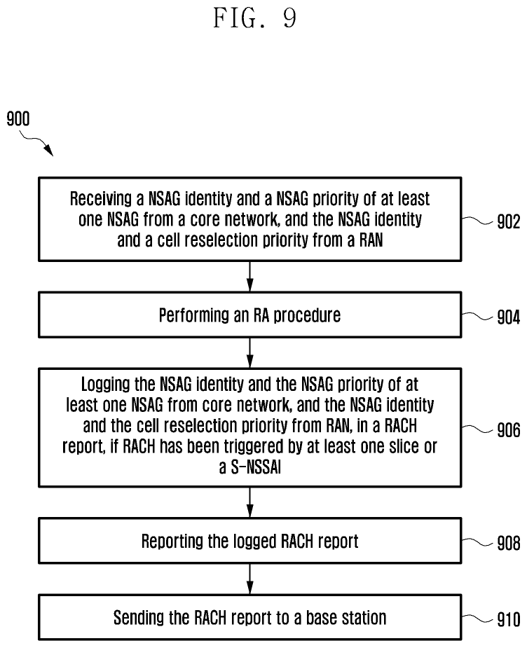

FIG. 9 illustrates a method 900 for performing self-optimization for handling of RACH report in wireless networks. The method 900 comprises receiving, by the processor 108 of the UE 102, a NSAG identity and a NSAG priority of at least one NSAG from a core network 106, and the NSAG identity and a cell reselection priority from a RAN, as depicted in step 902. The NSAG is associated with one or more slices or S-NSSAI(s). The UE 102 receives the NSAG identity and the NSAG priority of the NSAG via one or more NAS messages from the core network 106 (from core network functions like Access and Mobility Management Functions). The method 900 comprises performing, by the processor 108, an RA procedure, as depicted in step 904. The method 900 comprises logging, by the processor 108, the NSAG identity and the NSAG priority of at least one NSAG from the core network 106, and the NSAG identity and the cell reselection priority from the RAN, in a RACH report, if RACH has been triggered by at least one slice (or S-NSSAI) while the UE 102 is performing the RA procedure, as depicted in step 906. The method 900 comprises reporting, by the processor 108, the logged RACH report, as depicted in step 908. The method 900 comprises sending, by the processor 108, the RACH report to the base station of the network 104, as depicted in step 910. One or more NSAG identities of one or more NSAGs are listed in the order of one or more NAS provided NSAG priorities in the RACH report.

The various actions in method 900 may be performed in the order presented, in a different order or simultaneously. Further, in some embodiments, some actions listed in FIG. 9 may be omitted.

In an embodiment herein, the UE 102 provides information about NSAG identity and the NSAG priority (provided by NAS) of the NSAGs to which the S-NSSAIs of the slices that triggered RACH are associated in RACH report. If the RACH access is performed based on slicing (i.e., based on the NSAG that is part of feature combination), then the UE 102 logs the NSAG identity and the NAS provided NSAG priority of the NSAG which is associated with the S-NSSAI of the slice that triggered the RACH in the RACH report. Further, the UE 102 reports the logged RACH report. In other words, UE reports the NSAG ID and NSAG priority that is assigned to the S-NSSAI triggering the RA attempt and belongs to the NSAG ID of the feature combination used to select the RA configuration. If the RACH is triggered by more than one slice, the NSAG identity and the NAS provided NSAG priority of all the NSAGs associated with all those slices are included in the RACH report. The UE 102 may receive NSAG priority from Access and Mobility Management Function (AMF) through NAS messages like Registration Accept etc., and NSAGCellReselection-Priority from gNB through system information, and the AMF provided priority is included in the RACH report. In an embodiment herein, the UE 102 logs and reports the NSAG identity without reporting the associated Tracking Area Code (TAC)—i.e., NSAG-ID-r17. In an embodiment herein, the UE 102 may also log the TAC along with NSAG-ID-r17, for example, if the network is Non-Terrestrial Networks (NTN) network. In an embodiment herein, the information about the NAS provided priority is included implicitly in the RACH report, for example by sorting the list of NSAG identities in priority order or other implicit methods. In an embodiment herein, the NSAG identity of highest priority NSAG (highest priority among the NSAGs associated with the S-NSSAI of slices that triggered RACH) is included in the RACH report and informed to gNB that said NSAG is the highest priority NSAG (highest priority among the NSAGs associated with the S-NSSAI of slices that triggered RACH). This may be in addition to the list of all NSAGs that are related to the slices (i.e., associated with the N-SSAIs of the slices that triggered the RACH.)

In an embodiment herein, if the signaling transaction triggering the access attempt is related to more than one network slice and if the RACH attempt is related to more than one network slice and the S-NSSAIs of these network slices are associated to more than one NSAG for random access, then the UE 102 includes the NSAG identity and the NAS provided NSAG priorities of all those NSAGs in the RACH report, and sends the RACH report to the gNB. In an embodiment herein, for the above scenario, the NSAG identity of all such NSAGs are included, but the NAS provided NSAG priority of only the highest priority NSAG (highest priority among the NSAGs associated with the S-NSSAI of slices that triggered RACH) is included in the RACH report. In an embodiment herein, for the above scenario, the NSAG identity and NSAG priority of only the highest priority NSAG (highest priority among the NSAGs associated with the S-NSSAI of slices that triggered RACH) is included in the RACH report. In an embodiment herein, the UE 102 includes the NSAG identities of the NSAGs to which S-NSSAIs of the network slices that triggered the RACH attempt and also indicates to the gNB the identity of the highest priority NSAG (list of NSAGs triggered RACH including all NSAGs associated with RACH triggering and highest priority NSAG, the NSAG that is highest priority among the NSAGs that are associated to slices which triggered RACH). In an embodiment herein, the UE 102 provides these NSAG priorities implicitly to the network 104 without including the NAS provided priorities. In an embodiment herein, these NSAGs can be sorted in the order of the NAS provided NSAG priorities in the RACH report which can be sent to the gNB. This order may be ascending order. Alternatively, the order may be descending order.

In an embodiment herein, if the feature combination selected by the UE 102 is based on NSAG (or based on multiple features including NSAG) includes NSAG-List-r17, then the UE 102 includes the NSAG identity and NSAG priorities of all NSAGs in the NSAG-List-r17 for that feature combination in the RACH report.

In an embodiment herein, if the feature combination is selected based on the highest priority NSAG, then the UE 102 includes the identity of all the NSAGs associated to NSSAIs that triggered the RACH and either the priority of the highest priority NSAG among those NSAGs or all the NSAGs in the RACH report.

When the feature specific RACH is used and the RACH configuration from ad-ditional configuration (for example, AdditionalRACH-ConfigCommon) is applied, the UE 102 logs and reports the AdditionalRACH-ConfigCommon or the IEs from Addi-tionalRACH-ConfigCommon instead of the RACH-ConfigCommon or IEs from RACH-ConfigCommon. When RACH parameters are provided in featurecombinationpreambles, the UE 102 logs and reports the RACH parameters corresponding to the FeatureCombinationPreambles. If the UE 102 receives AdditionalRACH-ConfigCommon and featurecombinationpreambles and if some of the parameters for RACH are not present in AdditionalRACH-ConfigCommon or featurecombinationpreambles, then the UE 102 logs the corresponding parameters from RACH-ConfigCommon or MSG-AConfigCommon.

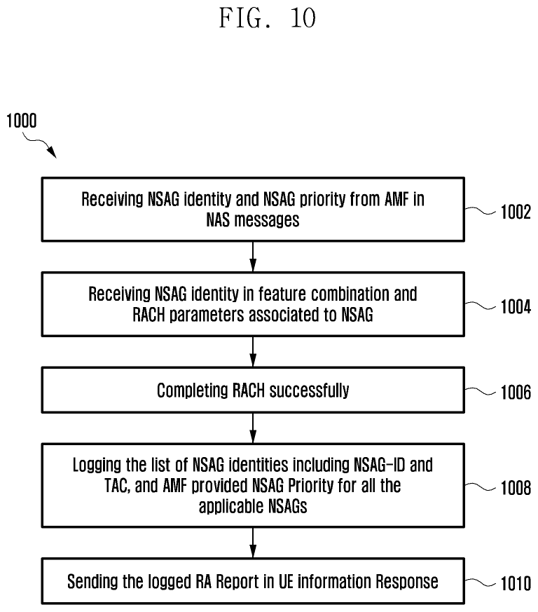

FIG. 10 illustrates a method 1000 for storing feature specific random access information in the UE 102 for NSAG. The method 1000 comprises receiving, by the processor 108 of the UE 102, NSAG identity and NSAG priority from AMF in NAS messages, as depicted in step 1002. The method 1000 comprises receiving, by the processor 108, NSAG identity in feature combination and the RACH parameters associated to NSAG, as depicted in step 1004. The method 1000 comprises performing, by the processor 108, RACH successfully with RLF or Connection Establishment Failure (CEF) or so on, as depicted in step 1006. RACH is applied based on NSAG. The UE 102 is configured for RACH report. The method 1000 comprises logging, by the processor 108, the list of NSAG identities including NSAG-ID and TAC, and AMF provided NSAG Priority for all the applicable NSAGs, as depicted in step 1008. The UE 102 logs applicable S-NSSAI for each NSAG. The method 1000 comprises sending, the logged RA Report in UE information response, as depicted in step 1010. Network nodes such as NR gNBs, retrieves these information and optimizes the random access resource allocation, the power allocation for RACH and various other parameters using this information.

The various actions in method 1000 may be performed in the order presented, in a different order or simultaneously. Further, in some embodiments, some actions listed in FIG. 10 may be omitted.

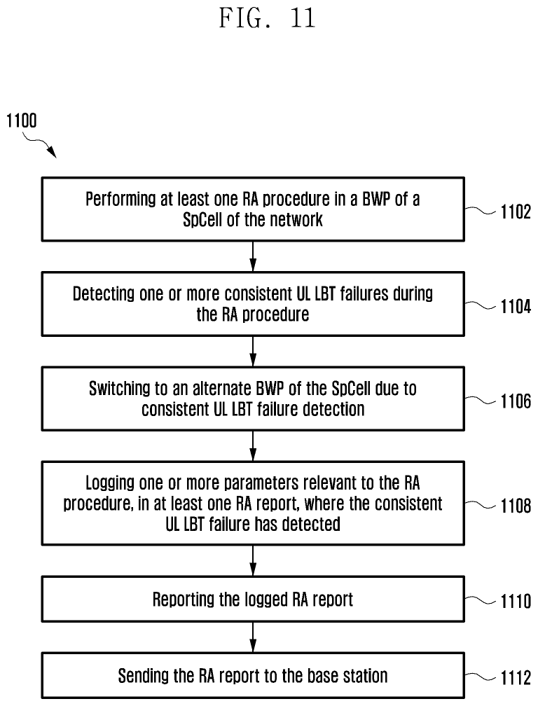

FIG. 11 illustrates a method 1100 for providing RA reporting during a RA procedure for consistent UL LBT failures in BWP in NR-U. The method 1100 comprises performing, by the processor 108 of the UE 102, at least one Random Access (RA) procedure in a Bandwidth Part (BWP) of a SpCell of the network 104, as depicted in step 1102. The method 1100 comprises detecting, by the processor 108, one or more consistent UL LBT failures during the RA procedure, as depicted in step 1104. The method 1100 comprises switching, by the processor 108, to an alternate BWP of the SpCell due to consistent UL LBT failure detection, as depicted in step 1106. The method 1100 comprises logging, by the processor 108, one or more parameters relevant to the RA procedure, in at least one RA report, where the consistent UL LBT failure has detected, as depicted in step 1108. The parameters relevant to the RA procedure can be, but not limited to, location and bandwidth information of the BWP, subcarrier spacing information of the BWP, and absolute frequency point information of the BWP. The method of logging the parameters relevant to the RA procedure is performed when the RA procedure is successful in the alternate BWP. The method 1100 comprises reporting, by the processor 108, the logged RA report, as depicted in step 1110. The method 1100 comprises sending, by the processor 108 the RA report to the base station of the network, as depicted in step 1112.

The various actions in method 1100 may be performed in the order presented, in a different order or simultaneously. Further, in some embodiments, some actions listed in FIG. 11 may be omitted.

In an embodiment herein, the UE 102 logs the information about the RA procedure for which consistent UL LBT failure occurred in a BWP of SpCell, in the RA report list structure (RA-ReportList-r16 as defined in 3GPP TS 38.331 V17.2.0). In an embodiment herein, the UE 102 logs the information about the RA procedure for which consistent UL LBT failure has occurred in each BWP of SpCell as a separate RA report (RA-Report-r16 as defined in 3GPP TS 38.331 V17.2.0) within the RA-ReportList-r16.

In an embodiment herein, the UE 102 logs the information about RA procedure for which consistent UL LBT failure has occurred in one or more BWP(s) of SpCell, only if the RA procedure is successful in another BWP. If the RA procedure fails in all the possible BWP of SpCell due to consistent UL LBT failure, thereby leading to MCG RLF or SCGFailure, then the UE 102 does not log the information about RA procedure for the consistent UL LBT failures in any of those failed BWP(s). In an alternate embodiment herein, the UE 102 may log the LBT recovery information for all the BWPs in RLF report, or the UE 102 may indicate whether the UE 102 tried RA in multiple BWPs in the RLF report. The UE 102 may also provide a flag to indicate whether LBT recovery information was provided in the RLF report.

When the RA procedure fails due to consistent UL LBT failures in multiple BWPs of SpCell, the UE 102 logs the information about the RA procedure in first N UL BWPs where the consistent UL LBT failure has occurred. Alternately, the UE 102 logs the information about the last N UL BWPs where the consistent UL LBT failure has occurred. In an embodiment herein, N specifies a maximum number of UL BWPs whose information may be logged are reported during consistent UL LBT failures in some BWPs followed by the successful random access procedure in another BWP. The value of N could be 1, 2, 3 for NR. The value of N could be less than the maximum number of BWPs that could be configured, i.e., the UE 102 may log only a few BWPs where the consistent UL LBT failure has occurred.

In an embodiment herein, when the UE 102 logs the RA information about the RA procedure for which consistent UL LBT failure occurred in each BWP of SpCell in a separate RA Report, then the UE 102 logs the RA report for maximum (M-P-1,N) BWPs where the RA is failed due consistent UL LBT failures. FIG. 1 depicts a process for RA reporting during RA for consistent UL LBT failures in some BWPs.

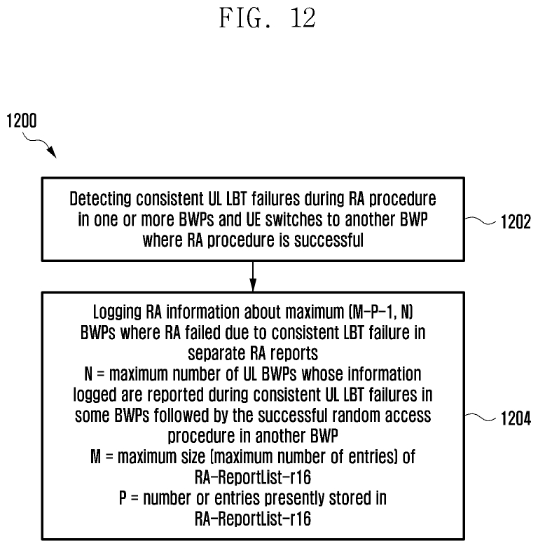

FIG. 12 illustrates a method 1200 for RA reporting during the RA procedure for consistent UL LBT failures in some BWPs. The method 1200 comprises detecting, by the processor 108 of the UE 102, consistent UL LBT failures during the RA procedure in one or more BWPs, and the UE 102 switches to another BWP where the RA procedure is successful, as depicted in step 1202. The method 1200 comprises logging, by the processor 108, RA information about maximum (M-P-1, N) BWPs, as depicted in step 1204, where RA failed due to consistent LBT failure in separate RA reports. For example,
N=maximum number of UL BWPs whose information is logged are reported during consistent UL LBT failures in some BWPs followed by the successful random access procedure in another BWP
M=maximum size (maximum number of entries) of RA-ReportList-r16.
P=number or entries presently stored in RA-ReportList-r16.

The various actions in method 1200 may be performed in the order presented, in a different order or simultaneously. Further, in some embodiments, some actions listed in FIG. 12 may be omitted.

For example, in NR R17, maximum size of RA-ReportList-r16 is 8; i.e., M=8. Assume that the UE 102 may store the RA report about consistent UL LBT failures for 3 BWPs, i.e., N=3. Again, consider that the number of entries presently stored in RA-ReportList-r16 is 6; i.e., P is 6. The UE 102 logs the RA report for maximum (M-P-1,N) BWPs where the RA is failed due consistent UL LBT failures; i.e., max(8-6-1, 3), i.e., 1.

Even though there may be consistent UL LBT failures in 2 or 3 BWPs, the UE 102 logs the RA report only for 1 BWP which experienced consistent UL LBT failures. The UE 102 logs RA report of the maximum (M-P-1,N) BWPs where consistent UL LBT failures has occurred during RA procedure, immediately before the successful RA procedure. Alternately, the UE 102 logs RA report of the maximum (M-P-1,N) BWPs where consistent UL LBT failures occurred during RA procedure, initially (i.e., the BWPs where RA failed (earlier) first due to consistent UL LBT failures) before the successful RA procedure. In both the cases, the UE 102 also logs the RA related report for the successful RA procedure in another BWP.

In an embodiment herein, the UE 102 stops logging the RA-Report in the RA-ReportList about RA procedure for which consistent UL LBT failure has occurred in certain BWP, when the size of RA-ReportList is 1 less than the maximum size of RA-ReportList. In an embodiment herein, the UE 102 overwrites the first RA-Report in the RA-ReportList about RA procedure for which consistent UL LBT failure occurred in certain BWP (first RA Report for the current sequence of switches of BWP due to consistent UL LBT failure), when the UE 102 needs to log RA information about a new RA procedure for which consistent UL LBT failure has occurred in certain BWPs.

In an embodiment herein, the UE 102 logs the information about RA procedure for which consistent UL LBT failure occurred in certain BWP in the RA report for the successful RA procedure in other BWP, for example, the UE 102 does not log separate RA reports for the RA procedure. Logging separate RA reports for each RA procedure where consistent LBT failure occurred may effectively reduce the number of RA reports the UE 102 can report for other purposes.

| | |
|---|---|
| RA-Report-r16 ::= | SEQUENCE { |
| cellId-r16 | CHOICE { |
| cellGlobalId-r16 | CGI-Info-Logging-r16, |
| pci-arfcn-r16 | PCI-ARFCN-NR-r16 |

},

| | |
|---|---|
| ra-InformationCommon-r16 | RA-InformationCommon-r16 |

OPTIONAL,

| | |
|---|---|
| raPurpose-r16 | ENUMERATED {accessRelated, |

beamFailureRecovery, reconfigurationWithSync, ulUnSynchronized,

| | | |
|---|---|---|
| schedulingRequestFailure, | noPUCCHResourceAvailable, | requestForOtherSI, |

```
  msg3RequestForOtherSI-r17, spare8, spare7, spare6, spare5, spare4, spare3, spare2,
spare1},
    ...,
    [[
```

| | |
|---|---|
| spCellID-r17 | CGI-Info-Logging-r16 |

```
  OPTIONAL
    ]]
```

| | |
|---|---|
| lbt_RAInformationCommon-r18 | LBT_RAInformationCommon-r18 |

```
  OPTIONAL,
  }
```

LBT_RAInformationCommon-r18 contains LBT information in other BWPs where consistent UL LBT failures have occurred during RA procedure, before switching to the BWP where RA is successful, and for which RA-InformationCommon is stored.

The UE 102 logs the BWP-Id of the BWPs where consistent UL LBT failure has occurred during RA procedure before switching to a BWP where RA procedure is successful.

In an embodiment herein, the UE 102 logs that RA purpose (raPurpose-r16) is logging the RA for consistent UL LBT failure occurred in certain BWP. In an embodiment herein, the UE 102 excludes RA-InformationCommon-r16 when logging the RA related information for a RA procedure, where the UE 102 experiences consistent UL LBT failure in a BWP. The UE 102 may include LBT_RAInformationCommon-r18 in the logged RA information.

In an embodiment herein, the UE 102 reports the logged information as per all of the embodiments to the gNB in RRC messages like UE Information Response. “Log” as discussed herein also means/includes “log and report to gNB” and “log and report to gNB when requested”

### Contents:

The variables are defined with respect to NR TS 38.331 v17.2.0 or TS 37.213 v17.2.0 specification. Equivalent functionality may be defined by other specifications for other technologies.

In an embodiment herein, the UE 102 excludes the following information elements while logging RA related information for a respective RA procedure in which the UE 102 experiences consistent UL LBT failure for a BWP. The UE 102 excludes the same while logging the LBT information for UL LBT failures (not consistent LBT failures) about RA in a successful RA procedure or while logging the LBT related information about RA in RLF report, Connection Establishment Failure (CEF) Report or Successful handover report (SHR).
a. msg1-SubcarrierSpacing-r16
b. msg1-SubcarrierSpacingCFRA-r16
c. msg1-FDM-r16
d. msg1-FDMCFRA-r16
e. msg1-SCS-From-prach-Configurationlndex-r16
f. msg1-SCS-From-prach-ConfigurationlndexCFRA-r16
g. msgA-SubcarrierSpacing-r17
h. msgA-RO-FDM-r17
i. msgA-RO-FDMCFRA-r17
j. msgA-SCS-From-prach-Configurationlndex-r17
k. msgA-TransMax-r17
l. msgA-MCS-r17
m. msgA-PUSCH-TimeDomainAllocation-r17
n. nrofMsgA-PO-FDM-r17
o. dlPathlossRSRP-r17
p. msgA-PUSCH-PayloadSize-r17
q. ssb-Index-r16
r. numberOfPreamblesSentOnSSB-rl6
s. csi-RS-Index-r16
t. contentionDetected-r16
u. dlRSRPAboveThreshold-r16
v. fallbackToFourStepRA-r17

In an embodiment herein, the UE 102 excludes the above information while logging the RA information (for example as in respective RA-Report) for a RA procedure in which the UE 102 experienced consistent UL LBT failure in the BWP and thereafter, the UE 102 switched to another BWP. The UE 102 excludes all of the above parameters (a. to v.), while logging the LBT information for UL LBT failures (not consistent LBT failures) or while logging the LBT related information RA in RLF report, Connection Failure Report or Successful handover report. In an embodiment herein, the UE 102 excludes one or more of the above information while logging the respective RA information. The UE 102 excludes at least one of the above parameters (a. to v.), while logging the LBT information for UL LBT failures (not consistent LBT failures) for a successful RA procedure or while logging the LBT related information about RA in RLF report, Connection Failure Report or Successful handover report.

In an embodiment herein, a UE, which logs the RA related information (RA report) for a RA procedure where it experienced consistent UL LBT failure in the BWP (and thereafter, the UE 102 switched to another BWP) always excludes the below information in the respective RA report, irrespective of whether it is using 2 step RACH, 4 step RACH or Contention Free Random Access (CFRA).
a. msgA-TransMax-r17
b. msgA-MCS-r17
c. fallbackToFourStepRA-r17
d. contentionDetected-r16
e. msgA-PUSCH-TimeDomainAllocation-r17

The UE 102 excludes the same (a. to e. above) while logging the LBT information for UL LBT failures (not consistent LBT failures) for a successful RA procedure or while logging the LBT related information about random access in RLF report, Connection Failure Report or Successful handover report.

In an embodiment herein, a UE 102 which logs the RA related information (RA report) for a RA procedure where the UE 102 experienced consistent UL LBT failure in the BWP (and thereafter, the UE switched to another BWP) includes one or more of the below information in the respective RA Report.
a. absoluteFrequencyPointA-r16
b. locationAndBandwidth-r16
c. msg1-FrequencyStart-r16, if the UE has performed contention based 4 step RA.
d. msg1-FrequencyStartCFRA-r16, if the UE has performed contention based 4 step RA.
e. msgA-RO-FrequencyStart-r17, if the UE has performed contention based 2 step RA.
f. msgA-RO-FrequencyStartCFRA-r17, if the UE has performed contention free 2 step RA.

The UE 102 includes the same (a. to f. above) while logging the LBT information for UL LBT failures (not consistent LBT failures) for a successful RA procedure or while logging the LBT related information about random access in RLF report, Connection Failure Report or Successful handover report.

In an embodiment herein, a UE which logs the RA related information (RA report) for a RA procedure where it experienced consistent UL LBT failure in the BWP (and thereafter, the UE switched to another BWP) includes whether the LBT failures are experienced during msg1 or msg3 or both, if the UE has performed 4 step RA. The UE also logs the number of LBT failures experienced in MSG1 and the number of LBT failures experienced in MSG3.

In an embodiment herein, a UE which has performed 4 step RACH, and has faced LBT failures, logs the number of LBT failures experienced in MSG1 and the number of LBT failures experienced in MSG3, irrespective of whether there is consistent UL LBT failures. The UE may also indicate a flag which informs whether the LBT failure is in MSG1 or MSG3.

In an embodiment herein, a UE which logs the RA related information (RA report) for a RA procedure where it experienced consistent UL LBT failure in the BWP (and thereafter, the UE switched to another BWP) includes whether the LBT failures are experienced during msgA and also whether the LBT failures are in the random access resources or Physical Uplink Shared Channel (PUSCH) resources if the UE has performed 2 step RA. The UE also logs the number of LBT failures experienced in RA resources and the number of LBT failures experienced in PUSCH resources.

In an embodiment herein, a UE which has performed 2 step RACH and has faced LBT failures, logs the number of LBT failures experienced in msgA and the number of LBT failures experienced in RACH resource and the number of LBT failures experienced in PUSCH resource (irrespective of whether there is consistent UL LBT failures).

In an embodiment herein, the UE which has faced LBT failures logs and reports the following in RA report or RLF report or SHR or CEF report.
a. Channel access type (type1/type2/type 2A/type 2B/type 2C/type 3 as specified in TS 37.213)
b. The channel were LBT has occurred. UE logs the information to identify the channel, for e.g., to identify the frequency of the channel. This could be the ARFCN of the carrier or the ARFCN for the start of the carrier or the number of resource blocks.
c. Channel occupancy measurements
d. Energy detection threshold
e. UL channel access priority class
f. The time UE has not transmitted due to LBT issues while T310 or T312 is running within RLF report/SHR report.
g. Contention window size
h. Contention window size timer.
i. maxEnergyDetectionThreshold
j. ChannelAccessMode-r16
k. absenceOfAnyOtherTechnology-r16
l. ul-toDL-COT-SharingED-Threshold-r16
m. semiStaticChannelAccessConfigUE
n. cg-COT-SharingList-r16
o. channelAccessMode2-r17
p. Various parameters configured by RRC signalling and used in the section 4.2.2 of TS 37.213 v17.2.0 for the contention window adjustment.
q. Various parameters used in the section 4.2.3 of TS 37.213 v17.2.0 for the energy detection threshold adaptation.
r. Various parameters configured by RRC signalling and used in the section 4.2.1 of TS 37.213 v17.2.0 for channel access procedures for uplink transmission(s).
s. Various parameters configured by RRC signalling and used in the section 4.3 and 4.4 of TS 37.213 V17.2.0.
t. ChannelAccessConfig-r16

A UE includes the total channel occupancy time while T310 or T312 is running in the RLF report or Successful handover report. The UE includes the sum of all the channel occupancy times obtained by channel occupancy procedures while T310 or T312 is running.

In an embodiment herein, all the above information related to RA may be stored per RA-attempt or per RA-procedure or per beam or per-RA ReportList.

The UE also may include the time RLF report is stored or SHR report is stored or RA report is stored in the corresponding reports. Alternatively, the UE may store the elapsed time from the time when the reports are stored to the time when the reports are sent while sending the RLF report or SHR report or RA report.

In an embodiment herein, when a UE logs RA related information for feature related RA in NR-U or non NR-U (non-shared spectrum) and when multiple features have triggered RA or used for selecting the RA partition, the triggered features (feature combinations) and/or the features used for selecting the feature specific RA partition are logged/listed in priority order (the priority here means featurePriorities-r17 broadcasted in SIB1 by a NR R17 gNB) in the RA Report and reported; i.e., they are sorted in the priority order and reported. In an embodiment herein, when multiple NSAGs have triggered random access, the triggered NSAGs are logged/listed in priority order (the priority here means NAS provided NSAG priorities) in the RA Report and reported; i.e., they are sorted in the order of NAS (AMF) provided priorities and reported. In an embodiment, UE logs the NSAG identity and priority of the highest priority NSAG which triggered the RA and/or which is used for selecting the feature specific RA partition. Network nodes such as NR gNBs, retrieves the information and optimizes various parameters related to random access using this information.

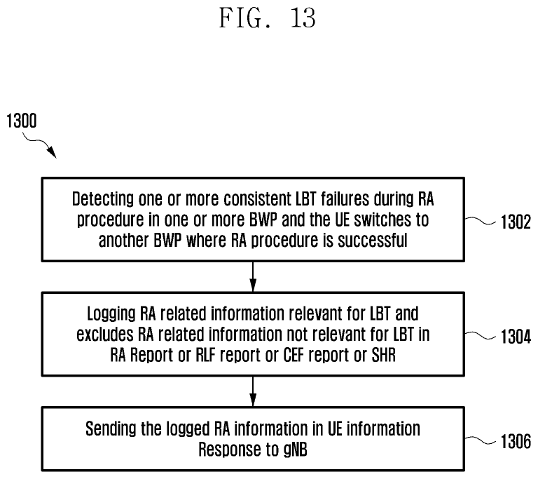

FIG. 13 illustrates a method 1300 for storing RA information for LBT failures. The method 1300 comprises detecting, by the processor 108 of the UE 102, one or more consistent LBT failures during RA procedure in one or more BWP and the UE 102 switches to another BWP where RA procedure is successful, as depicted in step 1302. The method 1300 comprises logging, by the processor 108, RA related information relevant for LBT and excludes RA related information not relevant for LBT in RA Report or RLF report or CEF report or SHR, as depicted in step 1304. The method 1300 comprises sending, by the processor 108, the logged RA information in UE information Response to gNB, as depicted in step 1306.

The various actions in method 1300 may be performed in the order presented, in a different order or simultaneously. Further, in some embodiments, some actions listed in FIG. 13 may be omitted.

The embodiments disclosed herein can be implemented through at least one software program running on at least one hardware device and performing network management functions to control the network elements. The modules and network elements shown in FIG. 1 include blocks which can be at least one of a hardware device, or a combination of hardware device and software module.

The embodiment disclosed herein describes a methods (300 to 1300) and systems 100 for SON/MDT optimizations in wireless networks. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

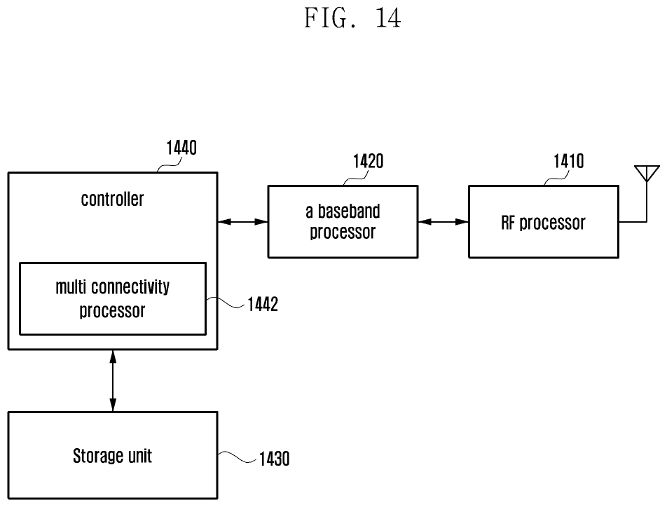

FIG. 14 illustrates a structure of the UE to which embodiments of the disclosure can be applied.

Referring to FIG. 14, the UE includes a radio frequency (RF) processor 1410, a baseband processor 1420, a storage unit 1430, and a controller 1440.

The RF processor 1410 performs a function for transmitting and receiving a signal through a wireless channel, such as band conversion and amplification of a signal. That is, the RF processor 1410 up-converts a baseband signal provided from the baseband processor 1420 into an RF band signal, transmits the RF band signal through an antenna, and then down-converts the RF band signal received through the antenna into a baseband signal. For example, the RF processor 1410 may include a transmission filter, a reception filter, an amplifier, a mixer, an oscillator, a digital-to-analog converter (DAC), an analog-to-digital converter (ADC), and the like. Although FIG. 14 illustrates only one antenna, the UE may include a plurality of antennas. In addition, the RF processor 1410 may include a plurality of RF chains. Moreover, the RF processor 1410 may perform beamforming. For the beamforming, the RF processor 1410 may control a phase and a size of each signal transmitted/received through a plurality of antennas or antenna elements. The RF processor may perform MIMO and receive a plurality of layers when performing the MIMO operation. The RF processor 1410 may appropriately configure a plurality of antennas or antenna elements according to the control of the controller to perform reception beam sweeping or control a direction of a reception beam and a beam width so that the reception beam corresponds to a transmission beam.

The baseband processor 1420 performs a function for a conversion between a baseband signal and a bitstream according to a physical layer standard of the system. For example, when data is transmitted, the baseband processor 1420 generates complex symbols by encoding and modulating a transmission bitstream. Further, when data is received, the baseband processor 1420 reconstructs a reception bitstream by demodulating and decoding a baseband signal provided from the RF processor 1410. For example, in an orthogonal frequency division multiplexing (OFDM) scheme, when data is transmitted, the baseband processor 1420 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 1420 divides the baseband signal provided from the RF processor 1410 in the unit of OFDM symbols, reconstructs the signals mapped to the subcarriers through a fast Fourier transform (FFT) operation, and then reconstructs a reception bitstream through demodulation and decoding.

The baseband processor 1420 and the RF processor 1410 transmit and receive signals as described above. Accordingly, the baseband processor 1420 and the RF processor 1410 may be referred to as a transmitter, a receiver, a transceiver, or a communication unit. Further, at least one of the baseband processor 1420 and the RF processor 1410 may include a plurality of communication modules to support a plurality of different radio access technologies. In addition, at least one of the baseband processor 1420 and the RF processor 1410 may include different communication modules to process signals of different frequency bands. For example, the different radio-access technologies may include an LTE network and an NR network. Further, the different frequency bands may include a super high frequency (SHF) (for example, 2.5 GHz and 5 Ghz) band and a millimeter (mm) wave (for example, 60 GHz) band.

The storage unit 1430 stores data such as basic program, an application, and setting information for the operation of the UE. The storage unit 1430 provides the stored data according to a request from the controller 1440.

The controller 1440 controls the overall operation of the UE. For example, the controller 1440 transmits/receives a signal through the baseband processor 1420 and the RF processor 1410. In addition, the controller 1440 may record data in the storage unit 1430 and read the data. To this end, the controller 1440 may include at least one processor. For example, the controller 1440 may include a communication processor (CP) that performs a control for communication, and an application processor (AP) that controls a higher layer such as an application program.

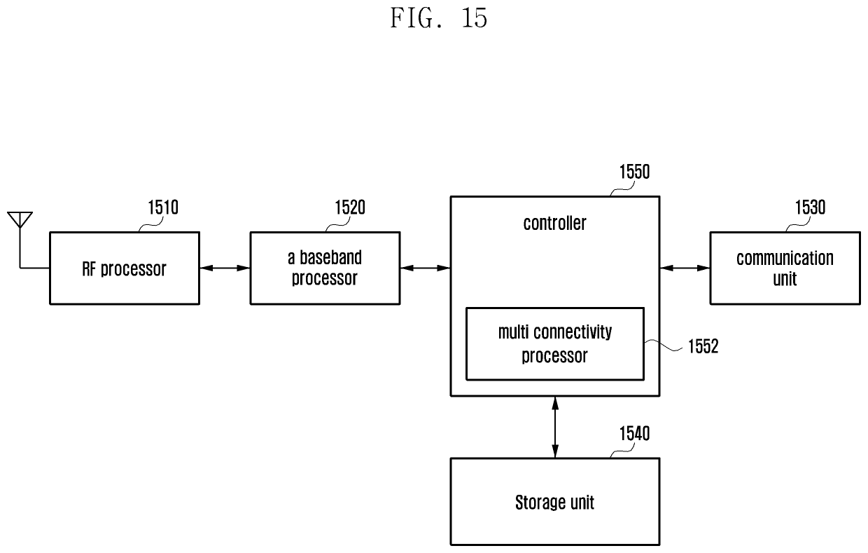

FIG. 15 illustrates a structure of the base station to which embodiments of the disclosure can be applied.

As illustrated in FIG. 15, the base station includes an RF processor 1510, a baseband processor 1520, a backhaul communication unit 1530, a storage unit 1540, and a controller 1550.

The RF processor 1510 performs a function for transmitting and receiving a signal through a wireless channel, such as band conversion and amplification of a signal. That is, the RF processor 1510 up-converts a baseband signal provided from the baseband processing unit 1520 into an RF band signal and then transmits the converted signal through an antenna, and down-converts an RF band signal received through the antenna into a baseband signal. For example, the RF processor 1510 may include a transmission filter, a reception filter, an amplifier, a mixer, an oscillator, a DAC, and an ADC. Although FIG. 15 illustrates only one antenna, the first access node may include a plurality of antennas. In addition, the RF processor 1510 may include a plurality of RF chains. Moreover, the RF processor 1510 may perform beamforming. For the beamforming, the RF processor 1510 may control a phase and a size of each of the signals transmitted and received through a plurality of antennas or antenna elements. The RF processor may perform a downlink MIMO operation by transmitting one or more layers.

The baseband processor 1520 performs a function of performing conversion between a baseband signal and a bitstream according to a physical layer standard of the first radio access technology. For example, when data is transmitted, the baseband processor 1520 generates complex symbols by encoding and modulating a transmission bitstream. Further, when data is received, the baseband processor 1520 reconstructs a reception bitstream by demodulating and decoding a baseband signal provided from the RF processor 1510. For example, in an OFDM scheme, when data is transmitted, the baseband processor 1520 may generate complex symbols by encoding and modulating the transmission bitstream, map the complex symbols to subcarriers, and then configure OFDM symbols through an IFFT operation and CP insertion. In addition, when data is received, the baseband processor 1520 divides a baseband signal provided from the RF processor 1510 in units of OFDM symbols, recovers signals mapped with sub-carriers through an FFT operation, and then recovers a reception bitstream through demodulation and decoding. The baseband processor 1520 and the RF processor 1510 transmit and receive signals as described above. Accordingly, the baseband processor 1520 and the RF processor 1510 may be referred to as a transmitter, a receiver, a transceiver, or a communication unit.

The communication unit 1530 provides an interface for communicating with other nodes within the network.

The storage unit 1540 stores data such as a basic program, an application, and setting information for the operation of the MeNB. Particularly, the storage unit 1540 may store information on bearers allocated to the accessed UE and the measurement result reported from the accessed UE. Further, the storage unit 1540 may store information on a reference for determining whether to provide multiple connections to the UE or stop the multiple connections. In addition, the storage unit 1540 provides data stored therein according to a request from the controller 1550.

The controller 1550 controls the overall operation of the MeNB. For example, the controller 1550 transmits and receives a signal through the baseband processor 1520 and the RF processor 1510 or through the backhaul communication unit 1530. In addition, the controller 1550 may record data in the storage unit 1540 and read the data. To this end, the controller 1550 may include at least one processor.

Although the present disclosure has been described with various embodiments, various changes and modifications may be suggested to one skilled in the art. It is intended that the present disclosure encompass such changes and modifications as fall within the scope of the appended claims.

The various actions, acts, blocks, steps, or the like in the flow charts may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method performed by a user equipment (UE) in a wireless communication system, the method comprising:
receiving, from a base station associated with a new radio (NR), a mobility command message including information indicating that a handover is triggered by an evolved packet system (EPS) fallback for an internet protocol (IP) multimedia subsystem (IMS) voice;
based on the mobility command message, detecting a failure of a mobility from the NR; and
in case that the UE selects a cell associated with evolved an universal mobile telecommunications system (UMTS) terrestrial radio access network (E-UTRA), setting a reconnected cell Id field in an UE variable of a radio link failure (RLF) report to a cell global identity (CGI) of the cell.

2. The method of claim 1, further comprising:
in case that the UE was not able to select the cell associated with the E-UTRA, setting a reestablishment field in the UE variable of the RLF report to a CGI of a cell associated with a radio resource control (RRC) reestablishment request message.

3. The method of claim 1, further comprising:
receiving, from the base station, a logged measurement configuration message including logged measurement type information indicating a signaling based logged measurement configuration; and
storing the logged measurement type information to a UE variable of a logged measurement report.

4. The method of claim 3, further comprising:
in case that a T330 timer is running, setting a signaling logged measurement configuration available information to true in an RRC Complete message; and
in case that the UE has logged measurements in the UE variable of the logged measurement report, setting the signaling logged measurement configuration available information to false in the RRC complete message.

5. The method of claim 4,
wherein the RRC Complete message is at least one of an RRC Setup Complete message, an RRC Reconfiguration Complete Message, or an RRC Reestablishment Complete message.

6. The method of claim 3,
further comprising:
transmitting, to the base station, UE capability information message indicating whether the UE supports an override protection of a signaling based logged measurement.

7. A method performed by a base station associated with in a wireless communication system, the method comprising:
generating a mobility command message including information indicating that a handover is triggered by an evolved packet system (EPS) fallback for an internet protocol (IP) multimedia subsystem (IMS) voice; and
transmitting, to a user equipment (UE), the mobility command message including information,
wherein in case that the UE selects a cell associated with evolved an universal mobile telecommunications system (UMTS) terrestrial radio access network (E-UTRA) after a failure of a mobility from a new radio (NR) based on the mobility command message, a reconnected cell Id field in an UE variable of a radio link failure (RLF) report is set to a cell global identity (CGI) of the cell, and
wherein the base station is associated with the NR.

8. The method of claim 7,
wherein in case that the UE was not able to select the cell associated with the E-UTRA, a reestablishment field in the UE variable of the RLF report is set to a CGI of a cell associated with a radio resource control (RRC) reestablishment request message.

9. The method of claim 8, further comprising:
transmitting, to the UE, a logged measurement configuration message including logged measurement type information indicating a signaling based logged measurement configuration,
wherein the logged measurement type
information is stored to an UE variable of a logged measurement report.

10. The method of claim 9, further comprising:
receiving, from the UE, UE capability information message indicating whether the UE supports an override protection of a signaling based logged measurement,
wherein in case that a T330 timer is running, a signaling logged measurement configuration available information is set to true in an RRC Complete message,
wherein in case that the UE has logged measurements in the UE variable of the logged measurement report, the signaling logged measurement configuration available information is set to false in the RRC complete message, and
wherein the RRC Complete message is at least one of an RRC Setup Complete message, an RRC Reconfiguration Complete Message, or an RRC Reestablishment Complete message.

11. A user equipment (UE) in a wireless communication system, the UE comprising:
a transceiver, and
a controller coupled with the transceiver, and configured to:
receive, from a base station associated with a new radio (NR), a mobility command message including information indicating that a handover is triggered by an evolved packet system (EPS) fallback for an internet protocol (IP) multimedia subsystem (IMS) voice,
based on the mobility command message, detect a failure of a mobility from the NR, and
in case that the UE selects a cell associated with evolved an universal mobile telecommunications system (UMTS) terrestrial radio access network (E-UTRA), set a reconnected cell Id field in an UE variable of a radio link failure (RLF) report to a cell global identity (CGI) of the cell.

12. The UE of claim 11, wherein the controller is further configured to:
in case that the UE was not able to select the cell associated with the E-UTRA, set a reestablishment field in the UE variable of the RLF report to a CGI of a cell associated with a radio resource control (RRC) reestablishment request message.

13. The UE of claim 11, wherein the controller is further configured to:
receive, from the base station, a logged measurement configuration message including logged measurement type information indicating a signaling based logged measurement configuration, and
store the logged measurement type information to an UE variable of a logged measurement report.

14. The UE of claim 11, wherein the controller is further configured to:
in case that a T330 timer is running, set a signaling logged measurement configuration available information to true in an RRC Complete message, and
in case that the UE has logged measurements in the UE variable of the logged measurement report, set the signaling logged measurement configuration available information to false in the RRC complete message.

15. The UE of claim 14,
wherein the RRC Complete message is at least one of an RRC Setup Complete message, an RRC Reconfiguration Complete Message, or an RRC Reestablishment Complete message.

16. The UE of claim 13, wherein the controller is further configured to:
transmit, to the base station, UE capability information message indicating whether the UE supports an override protection of a signaling based logged measurement.

17. A base station associated with in a wireless communication system, the base station comprising:
a transceiver, and
a controller coupled with the transceiver, and configured to:
generate a mobility command message including information indicating that a handover is triggered by an evolved packet system (EPS) fallback for an internet protocol (IP) multimedia subsystem (IMS) voice, and
transmit, to a user equipment (UE), the mobility command message including information,
wherein in case that the UE selects a cell associated with evolved an universal mobile telecommunications system (UMTS) terrestrial radio access network (E-UTRA) after a failure of a mobility from a new radio (NR) based on the mobility command message, a reconnected cell Id field in an UE variable of a radio link failure (RLF) report is set to a cell global identity (CGI) of the cell, and
wherein the base station is associated with the NR.

18. The base station of claim 17, wherein in case that the UE was not able to select the cell associated with the E-UTRA, a reestablishment field in the UE variable of the RLF report is set to a CGI of a cell associated with a radio resource control (RRC) reestablishment request message.

19. The base station of claim 17,
wherein the controller is further configured to:
transmit, to the UE, a logged measurement configuration message including logged measurement type information indicating a signaling based logged measurement configuration, and
wherein the logged measurement type information is stored to an UE variable of a logged measurement report.

20. The base station of claim 19,
wherein the controller is further configured to:
receive, from the UE, UE capability information message indicating whether the UE supports an override protection of a signaling based logged measurement,
wherein in case that a T330 timer is running, a signaling logged measurement configuration available information is set to true in an RRC Complete message,
wherein in case that the UE has logged measurements in the UE variable of the logged measurement report, the signaling logged measurement configuration available information is set to false in the RRC complete message, and
wherein the RRC Complete message is at least one of an RRC Setup Complete message, an RRC Reconfiguration Complete Message, or an RRC Reestablishment Complete message.
